(19) United States
(12) Patent Application Publication
(10) Pub. No.: US 2025/0383247 A1
(43) Pub. Date: Dec. 18, 2025

(54) MXene Coated Yarns And Textiles For Functional Fabric Devices

(71) Applicant: Drexel University, Philadelphia, PA (US)

(72) Inventors: Simge UZUN, Philadelphia, PA (US); Yury GOGOTSI, Warminster, PA (US); Genevieve DION, Philadelphia, PA (US); Amy L. STOLTZFUS, Philadelphia, PA (US)

(21) Appl. No.: 19/189,708

(22) Filed: Apr. 25, 2025

Related U.S. Application Data
(63) Continuation of application No. 17/291,718, filed on May 6, 2021, now abandoned.
(60) Provisional application No. 62/757,321, filed on Nov. 8, 2018.
(60) Provisional application No. 62/767,092, filed on Nov. 14, 2018.

(51) Int. Cl. G01L 1/22; D02G 3/36; D02G 3/44; D06M 11/58; D06M 11/74; G01L 19/00; G01L 19/14

(52) U.S. Cl. CPC G01L 1/2287; D02G 3/36; D02G 3/441; D06M 11/58; D06M 11/74; D10B 2401/16; D10B 2401/18; D10B 2403/02431; G01L 2019/0053; G01L 19/147

(57) ABSTRACT

Provided are textiles comprising one or both of MXene-coated fibers and MXene-coated yarns. The textiles are conductive, electroactive, and the fibers and yarns exhibit favorable mechanical and electrical properties, and can be incorporated into a variety of devices and uses.

### CROSS REFERENCE TO RELATED APPLICATIONS

The present disclosure is a continuation of U.S. patent application Ser. No. 17/291,718, “MXene Coated Yarns And Textiles For Functional Fabric Devices” (filed May 6, 2021); which is the National Stage Application of International Application No. PCT/US2019/060536 (filed Nov. 8, 2019); which claims priority to and the benefit of U.S. patent application No. 62/757,321, “MXene Coated Yarns And Textiles For Functional Fabric Devices” (filed Nov. 8, 2018) and U.S. patent application No. 62/767,092, “MXene Coated Yarns And Textiles For Functional Fabric Devices” (filed Nov. 14, 2018). All foregoing applications are incorporated herein by reference in their entireties for any and all purposes.

### TECHNICAL FIELD

The present disclosure is directed to fabrics and clothing containing functional textile devices.

### BACKGROUND

The recent surge of interest in textile-based electronics has directed research efforts towards designing multifunctional fibers and yarns. Electrically conducting yarns are quintessential for wearable applications because they can be engineered to perform specific functions in a wide array of technologies such as energy storage, sensing, actuation, and communication.

However, many challenges remain unaddressed regarding manufacturability of functional fibers and their integration in textiles. Current wearables utilize conventional batteries, which are bulky, uncomfortable, and can impose design limitations to the final product. Therefore, the development of flexible, electrochemically and electromechanically active yarns, which can be engineered and knitted into full fabrics provide new and practical insights for the scalable production of textile-based devices.

### SUMMARY

In meeting the long-felt needs described above, the present disclosure provides conductive fibers, comprising: a substrate fiber, the substrate fiber defining an outer surface coated with a first plurality of MXene particulates.

Also provided are yarns, comprising: a plurality of conductive fibers according to the present disclosure.

Further provided are yarns, comprising: a plurality of conductive fibers, the yarn defining an outer surface coated with a plurality of MXene particulates

Also provided are methods, comprising: forming a fiber according to the present disclosure.

Further provided are methods, comprising: forming a yarn according to the present disclosure.

Also disclosed are knitted, woven, or non-woven fabrics comprising a fiber according to the present disclosure, the knitted, woven, or non-woven fabric optionally being characterized as having a MXene loading level that changes by less than about 1% following washing for 45 hours (20 h at 30 deg. C., 5 h at 40 deg. C., 5 h at 50 deg. C., 5 h at 60 deg. C., 5 h at 70 deg. C., and 5 h at 80 deg. C.).

Further provided are knitted, woven, or non-woven fabrics comprising a yarn according to the present disclosure, the knitted, woven, or non-woven fabric optionally being characterized as having a MXene loading level that changes by less than about 1% following washing for 45 hours (20 h at 30 deg. C., 5 h at 40 deg. C., 5 h at 50 deg. C., 5 h at 60 deg. C., 5 h at 70 deg. C., and 5 h at 80 deg. C.).

Also provided are methods, comprising: coating a plurality of substrate fibers with a first plurality of MXene particulates so as to form coated substrate fibers.

Further provided are methods, comprising coating a plurality of substrate fibers with a plurality of MXene particulates so as to form coated yarns.

Additionally disclosed are devices, the device comprising a fiber according to the present disclosure or a yarn according to the present disclosure.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale.

FIG. 1. Seamlessly knitted MXene-coated cellulose-based yarns. Concept illustration of a garment integrated with energy storage and harvesting device with a capacitive pressure sensor. Insets show actual device prototypes comprising of a) Knitted energy storing fabric with alternating MXene-coated cotton yarn (black) and a non-conductive commercial viscose yarn (green). b) Knitted energy harvesting fabric with alternating MXene-coated linen yarn (black) and a commercial Teflon yarn (brown) can be placed strategically to harvest energy from body movements. c) Capacitive pressure sensor device knitted with MXene-coated bamboo yarn, where the device can sense different applied pressures ranging from low to high.

FIGS. 2A-2L. Characterization of Ti₃C₂ MXene dispersions. FIG. 2A) Digital photograph of ˜100 mL of MXene dispersion (˜20-25 mg/mL) in a petri dish with a schematic of the atomic structure of Ti₃C₂ MXene flake. FIG. 2B) Zeta potential (graph) at pH 6.8 and transmission electron microscopy (TEM) image (inset) of probe sonicated (S—Ti₃C₂) MXene flakes. FIG. 2C) Flake-size distribution of as-synthesized (L-Ti₃C₂) and S—Ti₃C₂ MXene dispersions. The size is represented as hydrodynamic diameter (d, nm) in nanometers. Insets: Scanning electron microscopy (SEM) images of S—Ti₃C₂ (Top) and L-Ti₃C₂ (Bottom) MXene flakes. Two-step coating process of highly conductive MXene-coated cotton yarns. First coating step (fiber coating) requires using S—Ti₃C₂ MXene flakes, which enables MXene penetration into the fiber level. Second coating step (yarn coating) uses L-Ti₃C₂ MXene flakes to cover the yarn surface to provide high conductivity. The schematic illustration of the cross-section of cotton yarn FIG. 2D) pristine, FIG. 2E) coated with S—Ti₃C₂ MXene flakes, FIG. 2F) coated with S—Ti₃C₂ and L-Ti₃C₂ MXene flakes. Cross-section SEM images of FIG. 2G) pristine cotton fibers, FIG. 2H) cotton fibers coated with S—Ti₃C₂ MXene flakes, FIG. 2I) cotton yarn after being coated with S—Ti₄C₂ and L-Ti₃C₂ MXene flakes. SEM images of the cotton yarn surface FIG. 2J) pristine, FIG. 2K) coated with S—Ti₃C₂ MXene flakes, and FIG. 2L) coated with S—Ti₃C₂ and L-Ti₃C₂ MXene flakes.

FIGS. 3A-3F. Different stitch patterns commonly used in knitted fabrics. FIG. 3A) Single jersey. FIG. 3B) Half gauge. FIG. 3C) Interlock. FIG. 3D) attempt to knit MXene-coated cotton yarn (black) in single jersey pattern. FIG. 3E) MXene-coated cotton yarn knitted with half gauge pattern resulted in a porous fabric. FIG. 3F) MXene-coated cotton yarn knitted with interlock pattern resulted in a dense fabric.

FIGS. 4A-4C. Washing durability performance of MXene-coated cotton yarns (˜2 mg/cm MXene loading) under various washing temperatures and times. FIG. 4A) The change in the MXene loading and the linear resistance as a function of washing temperature ranging from 30° C. to 80° C. Ti₂p XPS spectra of FIG. 4B) unwashed MXene-coated cotton yarn and FIG. 4C) washed MXene-coated cotton yarn after 3 min of sputtering. The yarns were washed for 20 washing cycles at 30° C. and 5 washing cycles at temperatures ranging from 40° C. to 80° C.

FIGS. 5A-5F. Electrochemical performance of MXene-coated cotton yarns with 78 wt. % (2.5 mg/cm) MXene loading using a three-electrode cell in 1 M H₂SO₄. FIG. 5A) Cyclic voltammetry (CV) curves (5 mV/s) at various operation potentials. FIG. 5B) CV curves of MXene-coated yarns at various scan rates. FIG. 5C) Galvanostatic charge-discharge (GCD) curves at various current densities. FIG. 5D) Rate capability of length and linear density capacitance of MXene-coated cotton yarns. FIG. 5E) Normalized Nyquist plot based on the length of the yarn, FIG. 5F) Cyclic stability of the MXene-coated cotton yarn during 10,000 cycles at a current density of 30 mA/cm.

FIGS. 6A-6F. Evaluation of sensing performance of the capacitive knitted pressure sensor device. FIG. 6A) Schematic representation of the capacitive pressure sensor (active area—16 mm×26 mm) assembled by using two knitted fabric electrodes and a dielectric layer. FIG. 6B) Electromechanical behavior of the knitted sensor. The applied strain is incrementally increased from 2.8% to 19.7%. Each cyclic deformation is repeated 20 times. FIG. 6C) Capacitance as a function of time at different compression strains ranging from 2.8% to 19.7%. The hold time is 10 seconds. FIG. 6D) Relative capacitance changes of the sensor at various strains. Gauge factor (GF) is derived from the linear fit. FIG. 6E) Cyclic stability of the sensor based on relative capacitance change at 14.1% strain for 2,000 cycles. FIG. 6F) Top: Digital photo of the knitted pressure sensor button (active area—16 mm×5 mm). Bottom: Capacitance output of the sensor when a gentle, moderate, or hard pressure is applied to the device by a finger.

FIGS. 7A-7D. FIG. 7A) X-ray diffraction (XRD) patterns of pristine cotton yarn, Ti₃C₂ MXene-coated cotton yarn, Ti₃C₂ MXene film (made with L-Ti₃C₂), and Ti₃AlC₂ MAX powder. Asterisk (*) indicates a second layer of intercalated water within the structure. The prefixes “M” and “C” in the composite spectra indicate MXene and cotton peaks, respectively. FIG. 7B) TEM image of L-Ti₃C₂ MXene flake. AFM images and the line profile of the FIG. 7C) S—Ti₃C₂ MXene flake and FIG. 7D) L-Ti₃C₂ MXene flake.

FIG. 8. Cross-section SEM images of cotton (top), bamboo (middle), and linen (bottom) yarns and fibers before and after Ti₃C₂ coating.

FIGS. 9A-9C. FIG. 9A) Resistance and conductivity change of the MXene-coated cotton, bamboo, and linen yarns as a function of length. FIG. 9B) Typical tensile stress-strain curves of pristine and MXene-coated cellulose-based yarns. FIG. 9C) SEM image of knotted MXene-coated cotton yarn with 78 wt. % active material loading.

FIGS. 10A-10C. SEM images of FIG. 10A) unwashed and FIG. 10B) washed MXene-coated cotton yarn surface. FIG. 10C) XPS spectrum of the washed MXene-coated cotton yarn without sputtering. The washed samples went through 20 washing cycles at 30° C. and 5 washing cycles ranging from 40° C. to 80° C.

FIGS. 11A-11B. SEM images of the a) pristine cotton yarn b) after 10,000 cycles in 1 M H₂SO₄.

FIGS. 12A-12F. Electrochemical performance of a symmetric MXene cotton yarn supercapacitor device using a cotton yarn with 2.2 mg/cm of MXene loading in 1 M PVA-H₂SO₄ gel electrolyte. FIG. 12A) CV curves at different scan rates, FIG. 12B) GCD curves at different current densities, FIG. 12C) Specific length and linear density capacitance of the device calculated from CV curves, FIG. 12D) Electrochemical impedance spectroscopy of yarn supercapacitor device, FIG. 12E) Capacitance retention and Coulombic efficiency versus cycle number at a current density of 5 mA/cm, FIG. 12F) Capacitance retention of the device under different bending angles. Inset shows capacitance retention after bending from 0° to 90°.

FIGS. 13A-13B provides exemplary showing that capacitance (C) increased with applied stress (FIG. 13A). Moreover, 20% and 50% increases in the capacitance response were observed when 5 g and 20 g weights were placed on the textile device, respectively (FIG. 13B).

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

The present invention relates to MXene coated conductive yarns and knitted fabrics (as well as woven and non-woven fabrics) and the use of such yarns to create functional textile devices seamlessly integrated into fabric products including but not limited to garments. The objective of the system described herein is to realize a low-cost, yarn coating system to create a variety of textile-based applications.

The invention includes the development of a facile and scalable dip-coating approach for producing highly conductive and durable MXene coated yarns. Concentration and flake size distribution of MXene dispersions are tailored to ensure penetration of MXene flakes at the fiber and/or yarn level. The coating process can be easily tailored to match specific conductivity and/or electrochemistry requirements for the desired final application.

Fibers are the fundamental units of yarns, and the yarns are the building blocks of the textiles. The commercial yarns used for dipping process include but not limited to natural, synthetic fibers, and their blends, such as cotton, bamboo, linen, modal, regenerated cellulose, nylon, polyester, viscose, and more.

The MXene-coated yarns can be utilized for various types of smart textile applications where conductivity is required. These include but are not limited to sensors (e.g. pressure, strain, moisture, and temperature), supercapacitors, triboelectric generators, antennas, and electromagnetic interference (EMI) shielding textiles. The coating process can be easily tailored based on the specific requirements of the target application.

An exemplary yarn MXene dip coating process is as follows.

Coating with small flakes: MXene dispersion with small flakes (˜250-400 nm) is used to dip-coat individual fibers. This type of coating retains the original property of the yarn and gives sufficient conductivity for variety of applications such as pressure and strain sensor. In case of a pressure sensor, when pressure is applied to the yarn, the small MXene flakes between individual fibers result in higher sensitivity to the changes in applied pressure due to higher possible number of contact points between the flakes.

Coating with large flakes: MXene dispersion with large flakes (e.g. 9.4%—6789 nm, 85%—940 nm, 5.6%—200.1 nm) is used to dip-coat yarn surface. When only MXene dispersions with large flakes are used to coat the yarns, the yarn surface would be completely covered with the MXene flakes and the pathway to the individual fibers would be blocked. This coating approach is useful when the conductivity is the priority for the application. This uniform, continuous and thin MXene coating on the yarn surface is ideal for electromagnetic interference (EMI) shielding applications. On the other hand, in case of electrochemistry applications, the ion diffusion is poor.

Coating with small and large flakes: combines the two methods described above to maximize the MXene loading both on the fiber and the yarn level. For instance, maximum amount of MXene coating is desirable for supercapacitors since the specific capacitance is directly proportional to the active material loading.

Electrochemical performance of MXene coated cotton yarns were evaluated using a standard three-electrode set-up with 1 M H₂SO₄ electrolyte. After evaluating the performance of MXene coated cotton yarns, yarn supercapacitors (YSC) are fabricated by using symmetric device configuration where both of the electrodes have the same amount of MXene loading. To the best of the inventors' knowledge, the cotton yarn with 2.2 mg/cm of MXene loading exhibits the highest specific capacitance among the cellulose-based yarn-shape supercapacitors reported to date. These capacitance values achieved from MXene-cotton yarns are higher or at the upper bound of the highest reported values among best performance yarn supercapacitors in the literature.

The yarns have shown the ability to withstand prolonged exposure to aqueous environments, a critical requirement for use in textile devices. MXene coated cotton yarns can withstand high washing temperatures (from 30° C. to 80° C.) for 45 washing cycles. Additionally, textiles from MXene-coated yarns have been produced on industrial machine.

### Textile Devices Made of MXene Coated Yarns

As a proof of concept, MXene coated bamboo yarns are knitted into a pressure sensor device using an industrial knitting machine. The sensor exhibits a constant (linear) gauge factor value of ˜6 at applied strains of up to ˜20% and demonstrates a high stability and linearity during the cyclic test (2000 cycles). The inventors manufactured this technology by using conductive MXene yarns and non-conductive commercial yarns through conventional knitting machines without the need of sewing or gluing conductive parts.

In addition to the pressure sensor, we demonstrated the feasibility of a textile interdigitated supercapacitor and triboelectric generator, and electromagnetic interference (EMI) shielding fabric devices with MXene coated yarns.

### Advantages and Impact

Nanomaterials have been incorporated into yarns via a variety of methods, including dip-coating, drop-casting, and biscrolling, and processed into fibers via wet-spinning and electrospinning. The dip-coating process is the most facile, simple, scalable, and environmentally friendly (no organic solvent required) method among others.

Conductive yarns are widely used in smart textile applications to provide properties like sensing, capacitance and more. Demonstrating the processability of these conductive yarns is crucial because high electrical conductivity, electrochemical, and electromechanical performance do not necessarily mean that the yarns can undergo industrial knitting or weaving processes. In order to produce true textile devices, the conductive yarns need to be knittable or weavable on industrial equipment. In this invention, we demonstrate that textile using MXene coated yarns can be produced on industrial equipment. MXene composite yarns produced with other methods (electrospinning, biscrolling, etc.) are not currently strong enough to be knitted or woven on industrial machines.

The MXene coated yarns demonstrate excellent washability over 45 washing cycles at temperatures ranging from 30° C. to 80° C.

A textile pressure sensor device as knitted with MXene coated yarns. This is the first wearable device produced with MXene yarns that does not require any post-processing to demonstrate its feasibility.

### MXenes

MXene compositions may comprise any of the compositions described elsewhere herein. Exemplary MXene compositions include those comprising:
(a) at least one layer having first and second surfaces, each layer described by a formula Mₙ₊₁Xₙ Tₓ and comprising:
substantially two-dimensional array of crystal cells, each crystal cell having an empirical formula of Mₙ₊₁Xₙ, such that
each X is positioned within an octahedral array of M, wherein
M is at least one Group IIIB, IVB, VB, or VIB metal or Mn, wherein
each X is C, N, or a combination thereof;
n=1, 2, or 3; and wherein
Tₓ represents surface termination groups; or
(b) at least one layer having first and second surfaces, each layer comprising:
a substantially two-dimensional array of crystal cells,
each crystal cell having an empirical formula of M′₂M″ₙXₙ₊₁Tₓ, such that each X is positioned within an octahedral array of M′ and M″, and where M″n are present as individual two-dimensional array of atoms intercalated between a pair of two-dimensional arrays of M′ atoms,
wherein M′ and M″ are different Group IIIB, IVB, VB, or VIB metals,
wherein each X is C, N, or a combination thereof;
n=1 or 2; and wherein

Tₓ represents surface termination groups. In certain of these exemplary embodiments, the at least one of said surfaces of each layer has surface termination groups (Tₓ) comprising alkoxide, carboxylate, halide, hydroxide, hydride, oxide, sub-oxide, nitride, sub-nitride, sulfide, thiol, or a combination thereof. In certain preferred embodiments, the MXene composition has an empirical formula of Ti₃C₂.

While the instant disclosure describes the use of Ti₃C₂, because of the convenient ability to prepare larger scale quantities of these materials, it is believed and expected that all other MXenes will perform similarly, and so all such MXene compositions are considered within the scope of this disclosure. In certain embodiments, the MXene composition is any of the compositions described in at least one of U.S. patent application Ser. No. 14/094,966 (filed Dec. 3, 2013), 62/055,155 (filed Sep. 25, 2014), 62/214,380 (filed Sep. 4, 2015), 62/149,890 (filed Apr. 20, 2015), 62/127,907 (filed Mar. 4, 2015) or International Applications PCT/US2012/043273 (filed Jun. 20, 2012), PCT/US2013/072733 (filed Dec. 3, 2013), PCT/US2015/051588 (filed Sep. 23, 2015), PCT/US2016/020216 (filed Mar. 1, 2016), or PCT/US2016/028,354 (filed Apr. 20, 2016), preferably where the MXene composition comprises titanium and carbon (e.g., Ti₃C₂, Ti₂C, Mo₂TiC₂, etc.). Each of these compositions is considered independent embodiment. Similarly, MXene carbides, nitrides, and carbonitrides are also considered independent embodiments. Various MXene compositions are described elsewhere herein, and these and other compositions, including coatings, stacks, laminates, molded forms, and other structures, described in the above-mentioned references are all considered within the scope of the present disclosure.

Where the MXene material is present as a coating on a conductive or non-conductive substrate, that MXene coating may cover some or all of the underlying substrate material. Such substrates may be virtually any conducting or non-conducting material, though preferably the MXene coating is superposed on a non-conductive surface. Such non-conductive surfaces or bodies may comprise virtually any non-electrically conducting organic or inorganic polymers. In independent embodiments, the substrate may be a non-porous, porous, microporous, or aerogel form of an organic polymer, for example, a fluorinated or perfluorinated polymer (e.g., PVDF, PTFE) or an alginate polymer, a silicate glass.

The coating may be patterned or unpatterned on the substrate. In independent embodiments, the coatings may be applied or result from the application by spin coating, dip coating, roller coating, compression molding, doctor blading, ink printing, painting or other such methods. Multiple coatings of the same or different MXene compositions may be employed.

The methods described in PCT/US2015/051588 (filed Sep. 23, 2015), incorporated by reference herein at least for such teachings, are suitable for such applications.

In independent embodiments, the MXene coating can be present and is operable, in virtually any thickness, from the nanometer scale to hundreds of microns. Within this range, in some embodiments, the MXene may be present at a thickness ranging from 1-2 nm to 1000 microns, or in a range defined by one or more of the ranges of from 1-2 nm to 25 nm, from 25 nm to 50 nm, from 50 nm to 100 nm, from 100 nm to 150 nm, from 150 nm to 200 nm, from 200 nm to 250 nm, from 250 nm to 500 nm, from 500 nm to 1000 nm, from 1000 nm to 1500 nm, from 1500 nm to 2500 nm, from 2500 nm to 5000 nm, from 5 μm to 100 μm, from 100 μm to 500 μm, or from 500 μm to 1000 μm.

Typically, in such coatings, the MXene is present as an overlapping array of two or more overlapping layers of MXene platelets oriented to be essentially coplanar with the substrate surface. In specific embodiments, the MXene platelets have at least one mean lateral dimension in a range of from about 0.1 micron to about 50 microns, or in a range defined by one or more of the ranges of from 0.1 microns to 2 microns, from 2 microns to 4 microns, from 4 microns to 6 microns, from 6 microns to 8 microns, from 8 microns to 10 microns, from 10 microns to 20 microns, from 20 microns to 30 microns, from 30 microns to 40 microns, or from 40 microns to 50 microns.

### Terms

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed disclosure. Embodiments described in terms of the phrase “comprising” (or its equivalents), also provide, as embodiments, those which are independently described in terms of “consisting of” and “consisting essentially of.” Where the term “consisting essentially of” is used, the basic and novel characteristic(s) of the method is intended to be the ability to provide ordered perovskite, perovskite-type, and perovskite-like films using MXene materials, which exhibit the crystallinity and properties described herein.

Throughout this specification, words are to be afforded their normal meaning, as would be understood by those skilled in the relevant art. However, so as to avoid misunderstanding, the meanings of certain terms will be specifically defined or clarified.

While MXene compositions include any and all of the compositions described in the patent applications and issued patents described above, in some embodiments, MXenes are materials comprising or consisting essentially of a Mₙ₊₁Xₙ(Tₓ) composition having at least one layer, each layer having a first and second surface, each layer comprising
a substantially two-dimensional array of crystal cells.
each crystal cell having an empirical formula of Mₙ₊₁Xₙ, such that each X is positioned within an octahedral array of M,
wherein M is at least one Group 3, 4, 5, 6, or 7, or Mn,
wherein each X is carbon and nitrogen or combination of both and
n=1, 2, or 3;
wherein at least one of said surfaces of the layers has surface terminations, Tₛ, independently comprising alkoxide, alkyl, carboxylate, halide, hydroxide, hydride, oxide, sub-oxide, nitride, sub-nitride, sulfide, sulfonate, thiol, or a combination thereof;

As described elsewhere within this disclosure, the Mₙ₊₁Xₙ(Tₓ) materials produced in these methods and compositions have at least one layer, and sometimes a plurality of layers, each layer having a first and second surface, each layer comprising a substantially two-dimensional array of crystal cells; each crystal cell having an empirical formula of Mₙ₊₁Xₙ, such that each X is positioned within an octahedral array of M, wherein M is at least one Group 3, 4, 5, 6, or 7 metal (corresponding to Group IIIB, IVB, VB, VIB or VIIB metal or Mn), wherein each X is C and/or N and n=1, 2, or 3; wherein at least one of said surfaces of the layers has surface terminations, Tₛ, comprising alkoxide, alkyl, carboxylate, halide, hydroxide, hydride, oxide, sub-oxide, nitride, sub-nitride, sulfide, sulfonate, thiol, or a combination thereof.

Supplementing the descriptions above, Mₙ₊₁Xₙ (Tₓ), compositions may be viewed as comprising free standing and stacked assemblies of two dimensional crystalline solids. Collectively, such compositions are referred to herein as “Mₙ₊₁Xₙ(Tₓ),” “MXene,” “MXene compositions,” or “MXene materials.” Additionally, these terms “Mₙ₊₁Xₙ (Tₓ),” “MXene,” “MXene compositions,” or “MXene materials” also refer to those compositions derived by the chemical exfoliation of MAX phase materials, whether these compositions are present as free-standing 2-dimensional or stacked assemblies (as described further below). Reference to the carbide equivalent to these terms reflects the fact that X is carbon, C, in the lattice. Such compositions comprise at least one layer having first and second surfaces, each layer comprising: a substantially two-dimensional array of crystal cells; each crystal cell having an empirical formula of Mₙ₊₁Xₙ, where M, X, and n are defined above. These compositions may be comprised of individual or a plurality of such layers. In some embodiments, the Mₙ₊₁Xₙ(Tₓ) MXenes comprising stacked assemblies may be capable of, or have atoms, ions, or molecules, that are intercalated between at least some of the layers. In other embodiments, these atoms or ions are lithium. In still other embodiments, these structures are part of an energy-storing device, such as a battery or supercapacitor. In still other embodiments these structures are added to polymers to make polymer composites.

The term “crystalline compositions comprising at least one layer having first and second surfaces, each layer comprising a substantially two-dimensional array of crystal cells” refers to the unique character of these MXene materials. For purposes of visualization, the two-dimensional array of crystal cells may be viewed as an array of cells extending in an x-y plane, with the z-axis defining the thickness of the composition, without any restrictions as to the absolute orientation of that plane or axes. It is preferred that the at least one layer having first and second surfaces contain but a single two-dimensional array of crystal cells (that is, the z-dimension is defined by the dimension of approximately one crystal cell), such that the planar surfaces of said cell array defines the surface of the layer; it should be appreciated that real compositions may contain portions having more than single crystal cell thicknesses.

That is, as used herein, “a substantially two-dimensional array of crystal cells” refers to an array which preferably includes a lateral (in x-y dimension) array of crystals having a thickness of a single cell, such that the top and bottom surfaces of the array are available for chemical modification.

Metals of Group 3, 4, 5, 6, or 7 (corresponding to Group IIIB, IVB, VB, VIB, or VIIB), either alone or in combination, said members including Ti, Zr, Hf, V, Nb, Ta, Cr, Mo, and W. For the purposes of this disclosure, the terms “M” or “M atoms,” “M elements,” or “M metals” may also include Mn. Also, for purposes of this disclosure, compositions where M comprises Ti, Zr, Hf, V, Nb, Ta, Cr, Mo, W, or mixtures thereof constitute independent embodiments. Similarly, the oxides of M may comprise any one or more of these materials as separate embodiments. For example, M may comprise any one or combination of Hf, Cr, Mn, Mo, Nb, Sc, Ta, Ti, V, W, or Zr. In other preferred embodiments, the transition metal is one or more of Ti, Zr, V, Cr, Mo, Nb, Ta, or a combination thereof. In even more preferred embodiments, the transition metal is Ti, Ta, Mo, Nb, V, Cr, or a combination thereof. Specific MXene metals may be used to provide dopant effects in the perovskite, perovskite-type, or perovskite-like lattices, or may be chosen to be chemically identical to one or more of the perovskite, perovskite-type, or perovskite-like lattices.

In certain specific embodiments, Mₙ₊₁Xₙ comprises Mₙ₊₁Cₙ (i.e., where X═C, carbon) which may be Ti₂C, V₂C, V₂N, Cr₂C, Zr₂C, Nb₂C, Hf₂C, Ta₂C, Mo₂C, Ti₃C₂, V₃C₂, Ta₃C₂, Mo₃C₂, (Cr_{2/3} Ti_{1/2})₃C₂, Ti₄C₃, V₄C₃, Ta₄C₃, Nb₄C₃, or a combination thereof.

In more specific embodiments, the Mₙ₊₁Xₙ(Tₓ) crystal cells have an empirical formula Ti₃C₂ or Ti₂C. In certain of these embodiments, at least one of said surfaces of each layer of these two dimensional crystal cells is coated with surface terminations, Tₛ, comprising alkoxide, fluoride, hydroxide, oxide, sub-oxide, sulfonate, or a combination thereof.

The range of compositions available can be seen as extending even further when one considers that each M-atom position within the overall Mₙ₊₁Xₙ matrix can be represented by more than one element. That is, one or more type of M-atom can occupy each M-position within the respective matrices. In certain exemplary non-limiting examples, these can be (M^{A}ₓM^{B}_{y})₂C, (M^{A}ₓM^{B}_{y})₃C₂, or (M^{A}ₓM^{B}_{y})₄C₃, where M^{A} and M^{B} are independently members of the same group, and x+y=1. For example, in but one non-limiting example, such a composition can be (V_{1/2}Cr_{1/2})₃C₂.

As those skilled in the art will appreciate, numerous modifications and variations of the present disclosure are possible in light of these teachings, and all such are contemplated hereby.

The disclosures of each patent, patent application, and publication cited or described in this document are hereby incorporated herein by reference, each in its entirety, for all purposes, or at least for the purpose described in the context in which the reference was presented.

### Additional Disclosure

There are various approaches in the literature to produce conductive and electrochemically active fibers and yarns. One common technique is the deposition of active material(s) onto a fiber/yarn substrate. This method is easily scalable and offers facile approach for incorporating various active materials into yarns. However, loading more than 30 wt. % of active material onto a fiber has remained a challenge for this method, resulting in fibers with low electrical conductivity and moderate electrochemical properties.

These results indicate the need for a more efficient coating approach that maximizes the active material loading while preventing their delamination from the yarn substrate during wear and washing. Wet-spinning has also been widely used to integrate active materials such as conductive polymers, graphene, and carbon nanotubes (CNTs) into fibers for energy storage and sensing applications. A biscrolling technique has also been developed that produces functional yarns by trapping active materials inside CNT sheets. These techniques achieved high loadings (up to ˜97 wt. %) of active materials into fibers or yarns. However, functional fibers or yarns produced using these methods seldom offer the mechanical properties required by textile processing and can be challenging to scale-up. In the context of wearables, manufacturability of the yarns is crucial because high electrical conductivity and electrochemical performance do not necessarily correspond to the feasibility of industrial-scale knitting or weaving processes. When considering the use of functional yarns in truly wearable applications, washability also becomes important. The ability to withstand prolonged exposure to aqueous environments is necessary for practical applications because textiles undergo various washing cycles after use.

The above limitations have led the inventors to develop fabrication of knittable, washable, and highly conductive yarn electrodes using MXenes. MXenes are a large family of two-dimensional (2D) transition metal carbides and nitrides which have a general formula of Mₙ₊₁XₙTₓ, where M is a transition metal, X is carbon and/or nitrogen with n=1, 2, or 3, and Tₓ denotes the surface termination (—OH, —O, and —F). MXenes have attracted significant attention due to their high electrical conductivity (up to 10,000 S/cm as a thin film) and excellent volumetric capacitance (up to 1,500 F/cm³). Their hydrophilic surface, due to the presence of abundant functional groups, makes them suitable for solution processing by spray-coating, vacuum-assisted filtration, printing and painting from aqueous solutions.

Ti₃C₂Tₓ MXene (referred to as Ti₃C₂ for simplicity) has demonstrated exceptional cation intercalation and pseudocapacitive behavior, which is ideal for energy storage applications. Ti₃C₂ MXene is also biocompatible and does not present a risk in case of contact with skin. Environmental degradation or incineration of Ti₃C₂ produces titanium dioxide (TiO₂) and carbon dioxide (CO₂), which do not present threats to the environment.

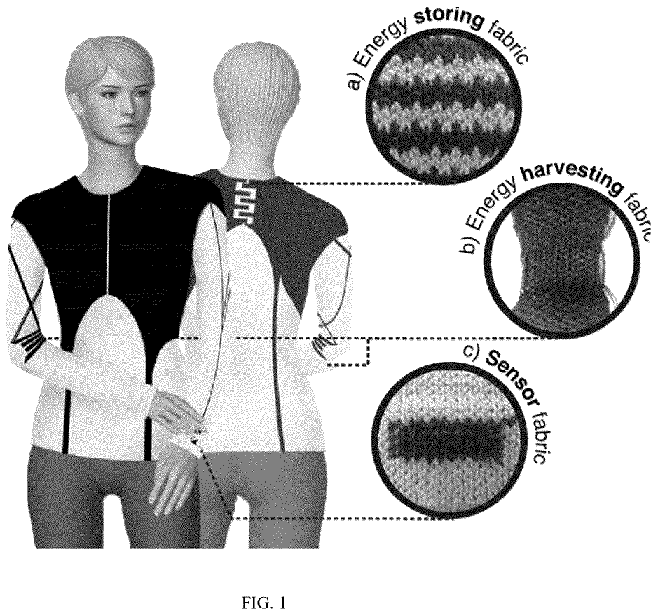

By using Ti₃C₂ as an active material, we employed a simple two-step dipping and drying procedure and converted conventional cellulose-based yarns such as cotton, bamboo, and linen into yarn electrodes. These MXene-coated yarns demonstrate three orders of magnitude increase in electrical conductivity and one order of magnitude increase in electrochemical performance when compared to carbon materials. By optimizing the coating process and carefully choosing appropriate MXene sheet size at each step of the coating process, we achieve yarns with a high loading of 78 wt. % MXene. We demonstrate that these yarns can be washed at temperatures ranging from 30° C. to 80° C. for 45 washing cycles and with minimal decrease in conductivity. We further show that for the first time, these yarns can be knitted into various stitch patterns using an industrial scale knitting machine, which were only achieved by simulation in previous reports (FIG. 1). The electrochemical performance of MXene-coated cotton yarns show that they have the potential to power wearable electronics as yarn supercapacitor devices. We also demonstrated that the knitted MXene-coated yarns can be used to make a flexible and wearable capacitive pressure sensor. While the scope of this work focuses on MXene-coated cellulose-based yarns and demonstration of energy storage and pressure sensing applications, these yarns offer electrical and electrochemical properties that can meet the requirements of other applications such as in energy harvesting, other types of sensors (e.g., strain, moisture, and temperature), antennas, heaters, and electromagnetic interference (EMI) shielding. Such functional yarns offer a platform technology, which utilizes these conformal yarns to enable development of various types of textile-based devices.

### Results

### Production of Conductive MXene-Coated Cellulose-Based Yarns

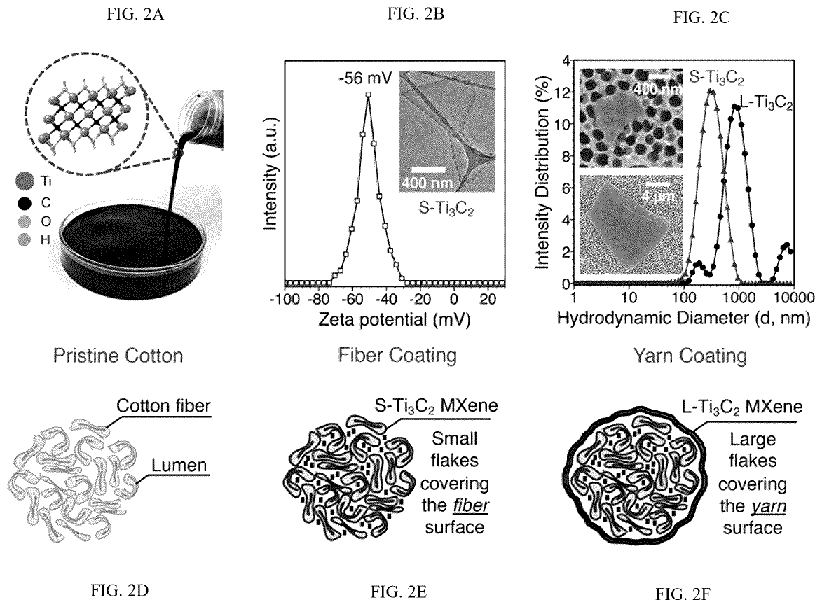

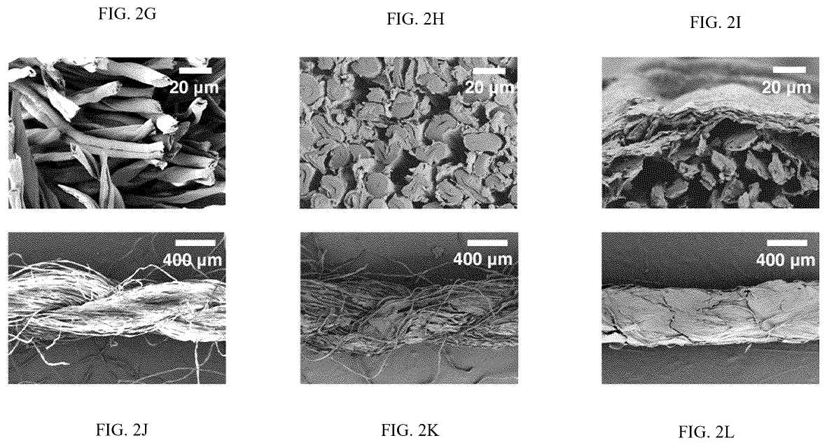

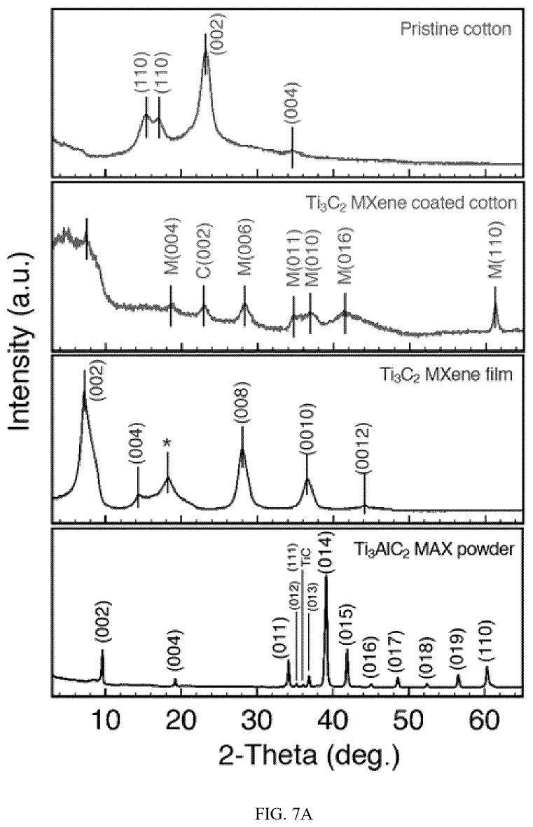

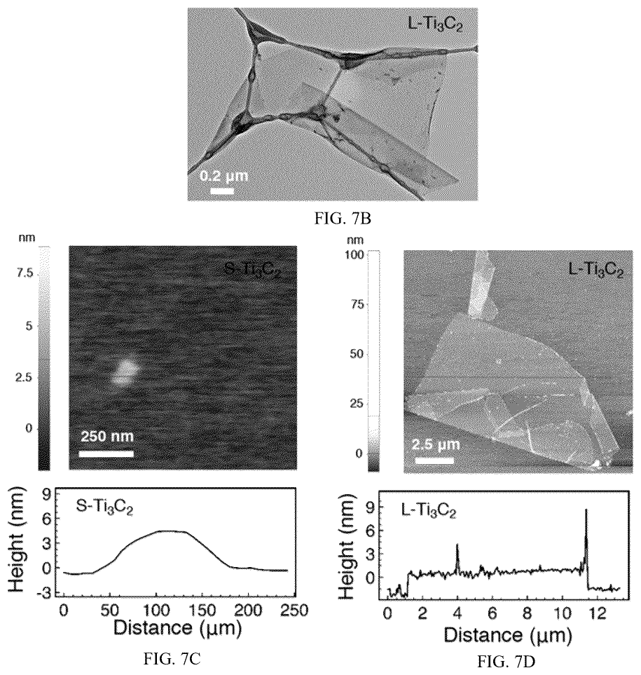

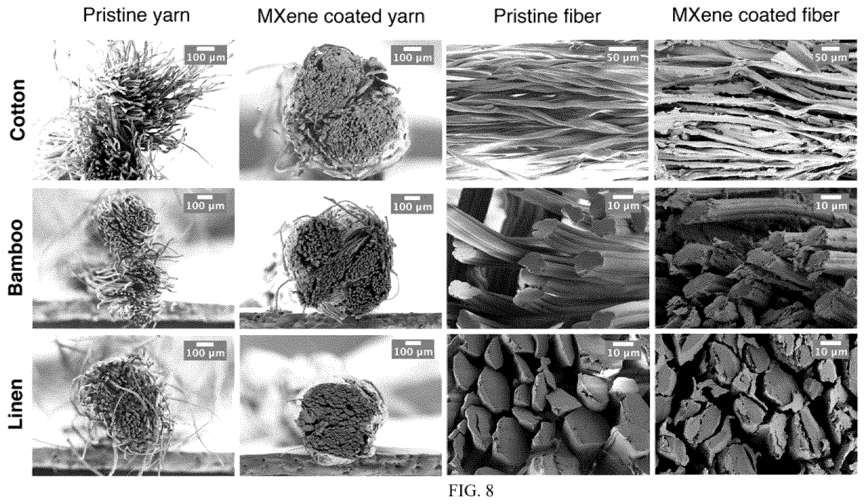

The initial step in producing the MXene-coated yarns begins with solution processing of MXene into homogenous dispersions (FIG. 2A). X-ray diffraction (XRD) results indicated the successful etching of Al layers and exfoliation of MXene by the expansion and disorder of the interlayer spacing according to the (002) peak (FIG. 7A). The disappearance of the (014) peak in the resulting Ti₃C₂ films indicated there is no residual MAX phase. Transmission electron microscopy (TEM) studies confirmed the synthesis of delaminated MXene nanosheets (small MXene flakes, S—Ti₃C₂, Inset of FIG. 2B and the large MXene flakes, L-Ti₃C₂, FIG. 7B). FIGS. 7C and 7D show an atomic force microscopy (AFM) images of S—Ti₃C₂ and L-Ti₃C₂ MXene flakes, respectively. The concentration of the MXene dispersions used during dipping was between 25-30 mg/mL.

MXene flakes are negatively charged and hydrophilic due to their surface functional groups (e.g., —O, —OH, and —F). As shown in FIG. 2B, the zeta potential of the Ti₃C₂ MXene flakes was measured as −56 mV at pH 6.8. When hydrophilic cotton yarns were dipped into negatively charged MXene dispersions, MXene flakes attached to the surface of cotton fibers. As a result, strong electrostatic interactions were established between MXene flakes and cotton fibers. The XRD pattern for Ti₃C₂-coated cotton yarn shows signatures of both Ti₃C₂ MXene and cotton peaks (FIG. 7A). In order to increase the overall active material loading during the dip-coating process, MXene dispersions with two different flake size distributions were used in this study: as-synthesized (L-Ti₃C₂ MXene) and probe sonicated (S—Ti₃C₂ MXene). According to the dynamic light scattering (DLS) results (FIG. 2C), L-Ti₃C₂ MXene dispersions were primarily composed of large flakes with an average particle size of 1 μm, whereas the S—Ti₃C₂ MXene dispersions were composed of nanoscale-sized flakes with an average particle size of 340 nm. Scanning electron microscopy (SEM) images of S—Ti₃C₂ and L-Ti₃C₂ MXene flakes (Inset of FIG. 2C) are in agreement with the DLS data. It has been shown that L-Ti₃C₂ MXene flakes result in higher electrical conductivity compared to S—Ti₃C₂ MXene flakes, which is most likely due to less interfacial resistance between L-Ti₃C₂ MXene flakes. Films made by filtering L-Ti₃C₂ MXene flakes showed higher electrical conductivity of ˜9490 S/cm, whereas the films produced by filtering S—Ti₃C₂ MXene flakes resulted in electrical conductivity of ˜4080 S/cm.

Three different approaches for producing conductive yarns with MXene dispersions were studied: (1) coating with S—Ti₃C₂ MXene, (2) L-Ti₃C₂ MXene, and (3) combination of small and large flakes. The pristine cotton yarn consists of twisted cotton fibers, which have a kidney-shaped cross-section with a hollow core (lumen) as illustrated in FIG. 2D. Unlike most synthetic yarns, cotton fibers have a rough surface (FIG. 2G), which is ideal for nanoparticle adhesion. The first coating process consisted of using only S—Ti₃C₂ MXene dispersions to allow for small MXene flakes to infiltrate between individual fibers (FIG. 2E, 2H). Using this coating method, the cotton yarn retained its flexibility. The conductivity of S—Ti₃C₂-coated cellulose-based yarns with MXene loadings of 0.6 mg/cm was between 30 and 50 S/cm, which is sufficient for a variety of applications such as pressure and strain sensing. The second coating method utilized L-Ti₃C₂ MXene dispersions to achieve MXene coating only on the surface of the yarn. When only MXene dispersions with large flakes were used to coat the yarns, the formation of MXene coating on the yarn surface prevented the further infiltration of MXene flakes into the internal yarn structure, thereby leaving the individual fibers closer to the center uncoated. The conductivity of L-Ti₃C₂-coated cellulose-based yarns ranges from 60 to 85 S/cm (MXene loading of 0.6 mg/cm), which is higher than the conductivity of the yarns coated only with S—Ti₃C₂ MXene flakes. Even though higher conductivity is achieved with L-Ti₃C₂-coated cellulose-based yarns, the yarns become less flexible. Notably, as the L-Ti₃C₂ MXene loading increased up to 0.6 mg/cm, MXene coating easily delaminated from the yarn surface upon forming the loops during knitting. Thus, the yarns coated with only L-Ti₃C₂ MXene flakes were not integrated into functional devices.

In order to balance the flexibility and the conductivity of the MXene coated yarns, we first infiltrated the internal yarn structure with S—Ti₃C₂ MXene in order to coat the individual fibers before finally coating the external yarn with L-Ti₃C₂ MXene. This approach, the two-step coating process, maximizes the MXene loading by coating both on the fiber and the yarn level.

In order to maximize MXene loading on the yarn, the fibers were first saturated with S—Ti₃C₂ MXene flakes before coating with L-Ti₃C₂ MXenes to cover the yarn surface (FIG. 2F, 2I). This coating approach could be ideal for yarn and textile supercapacitor applications since the capacitance has been reported to be MXene loading dependent.^{[10]} The cotton yarn surface after coating with only S—Ti₃C₂ (FIG. 2K) remained similar to the pristine cotton (FIG. 2Jj) in terms of flexibility because majority of the small flakes infiltrated into the fiber. On the other hand, the twist became no longer visible after coating with both S—Ti₃C₂ and L-Ti₃C₂ MXene dispersions (FIG. 2L), which created a continuous conductive pathway along the yarn surface. The yarns produced via two-step dip coating process were not as flexible as the yarns coated with only S—Ti₃C₂ MXene dispersions.

However, they demonstrated easier knittability and less flaking compared to the yarns coated with only L-Ti₃C₂ MXene dispersions. This is most likely due to a more balanced weight distribution between the center and the outside of the yarn achieved with the two-step dip coating process, where the presence of S—Ti₃C₂ MXene flakes at the internal yarn structure helped to balance the yarn's weight compared to only the presence of cotton fibers when the yarn surface only coated with L-Ti₃C₂ MXene dispersions. The same coating process was also applied to bamboo and linen yarns to demonstrate the adaptability of this method to other cellulose-based yarns. More detailed cross-sectional SEM images of the pristine and MXene-coated cotton, bamboo, and linen yarns are shown in FIG. 8. The MXene-coated yarns were dried thoroughly in air and subsequently placed in a vacuum desiccator prior to further evaluation.

To determine the mass loading of MXene, each yarn was weighed before and after dip-coating with MXene. The masses were averaged from three skeins with 200 cm length in order to account for mass variation along the length of the yarn. By following the two-step coating procedure, the active mass loading of up to 78 wt. % (2.5 mg/cm) could be achieved with cotton yarns. MXene-coated bamboo and linen yarns showed similar MXene loadings of ˜75 wt. % (2.2 mg/cm) and ˜77 wt. % (2.2 mg/cm), respectively. To the best of our knowledge, the active mass loading of ˜78 wt. % deposited on the yarns is the highest reported value in the literature for a facile, yarn dip-coating approach.

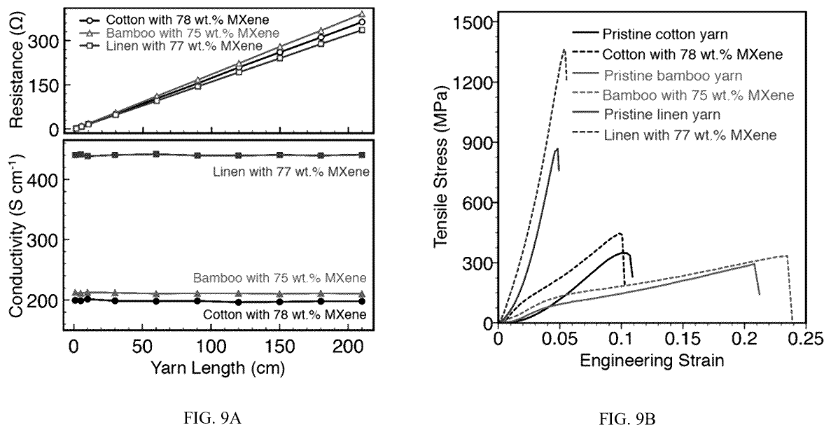

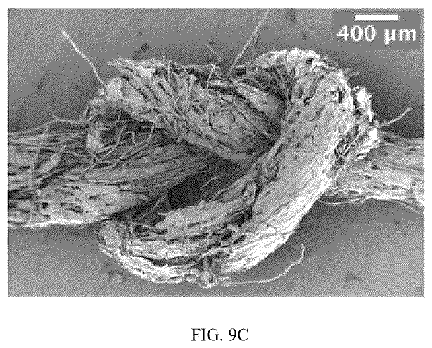

Investigation of the changes in resistance and conductivity of the MXene-coated cellulose-based yarns with length (FIG. 9A) revealed that the resistance increased linearly as a function of yarn length, thus the conductivity remained unchanged when the yarn length increased from ˜1 to ˜210 cm. At the highest MXene loading of 78 wt. %, the conductivity of the MXene-coated cotton yarn reached 198.5±1.4 S/cm (1.7±0.2 Ω/cm, yarn diameter ˜610 μm). While bamboo yarns with 75 wt. % MXene loading exhibited similar conductivity values with MXene-coated cotton yarns, the conductivity of the linen yarns with 77 wt. % MXene loading reached 440.3±0.9 S/cm, which is ˜2.2-times higher than MXene-coated cotton and bamboo yarns. Since linen yarns possess the smallest diameter (˜425 μm) among all examined yarns (˜610 μm for cotton and ˜570 μm for bamboo), the improved conductivity of the MXene-coated linen yarns can be attributed to the ˜1.8-times higher MXene loading per unit volume of the linen yarn compared to cotton and bamboo yarns. Moreover, linen fibers (60-120 cm) are the longest fibers studied in this paper when compared to cotton (1-4 cm) and bamboo (5-8 cm) fibers. Similar to S—Ti₃C₂ vs. L-Ti₃C₂ MXene flakes, longer fibers infiltrated with MXene flakes help to decrease the overall interfacial resistance along the yarn length by creating more effective conduction paths. Mechanical testing of MXene-coated cellulose-based yarns at the maximum active material loading (75-78 wt. %) shows that MXene addition also reinforces the yarn, improving the mechanical properties (FIG. 9B). For instance, at 78 wt. % MXene, the cotton yarn showed a Young's modulus of 5.0±0.3 GPa and a tensile strength of 468.4±27.1 MPa, which were ˜7% and ˜40% higher than those of the pristine cotton yarns, respectively. Moreover, MXene-coated cotton yarn (78 wt. % MXene loading) can form a knot (FIG. 9C), indicating good flexibility and knittability. Thus, coating of cellulose-based yarns with Ti₃C₂ MXene dispersions resulted in flexible and mechanically stable yarns that offer good electrical conductivity and high active material loading for a variety of promising applications.

### Knittability of MXene-Coated Cellulose-Based Yarns

We investigated the knittability of the MXene-coated cellulose-based yarns, including cotton, linen, and bamboo into full fabrics on an industrial machine using different stitch patterns. Knitting, the intermeshing of yarn loops to form a textile, was chosen due to its flexibility in programming and rapid prototyping. During industrial knitting process, the yarns are subjected to uniaxial tensile and bending stresses, making the overall stress much higher in comparison to hand knitting. Knitting cotton yarns coated with active materials with industrial machines was not possible for a long time as discussed in previous literature.

One of the reasons is that the cotton fibers are more likely to pull apart from each other while under tension during knitting since they consist of shorter fibers (1-4 cm) in comparison to other cellulose-based yarns (5-8 cm for bamboo and 60-120 cm for linen). The MXene-coated yarns are stronger and less flexible compared to their pristine counterparts. We addressed their reduced flexibility (after coating) by optimizing the stitch patterns through extensive parametric studies.

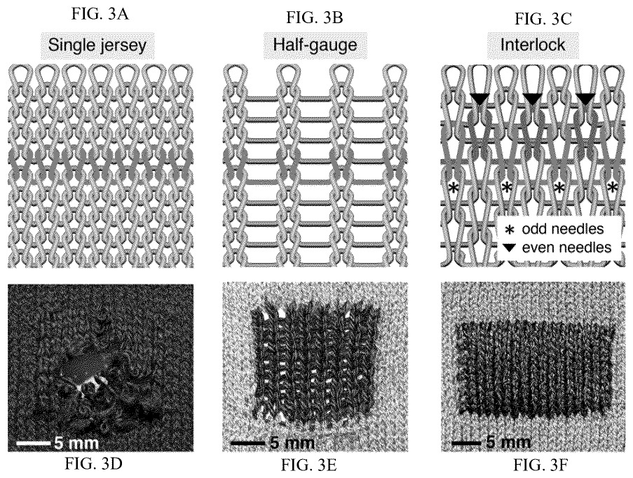

Here, we successfully knitted MXene-coated cotton and other cellulose-based yarns into swatches (fabric samples with 60 mm×65 mm in total area and 16 mm×26 mm in active area) and investigated different stitch patterns (geometric construction of the knitted loops) including single jersey (FIG. 3A), half-gauge (FIG. 3B), and interlock (FIG. 3C). The stitch pattern dictates how the yarns are inter-looped to create different knit structures. Single jersey is the most common fabric type and simplest loop structure among knitted textiles. However, it is not necessarily the ideal stitch pattern when it comes to knitting the coated yarns since these yarns exhibit lower flexibility compared to their pristine states. In jersey knits, the loops are formed using every needle adjacent to each other on the needle bed. This can result in yarn-to-yarn rubbing and breakage due to a smaller bending radius of the yarn during knitting (FIG. 3D). To prevent the yarn breakage, a half-gauge pattern can be knitted. Half-gauge knit uses every other needle on the bed in each machine pass, resulting in a more porous fabric (FIG. 3E). The interlock pattern (FIG. 3F), also uses every other needle but knits all needles in two passes. Odd needles (denoted with asterisks) are knitted in the first machine pass and the even needles (denoted with triangles) are knitted during the second pass of the sequence. The interlock pattern (FIG. 3F) results in a fabric closer in density to single jersey and is denser compared to the half-gauge pattern. Thus, utilization of half-gauge and interlock stitch patterns increased the space between each line of the loops and reduced the yarn-to-yarn friction and yarn breakage. The ability to knit MXene-coated cellulose-based yarns with different stitch patterns allowed us to control the fabric properties such as porosity and thickness for various applications. Understanding the properties and the limitations of conductive yarns enabled us to adjust the stitch patterns and the corresponding knitting parameters in order to knit these yarns.

### Washability of MXene-Coated Cellulose-Based Yarns

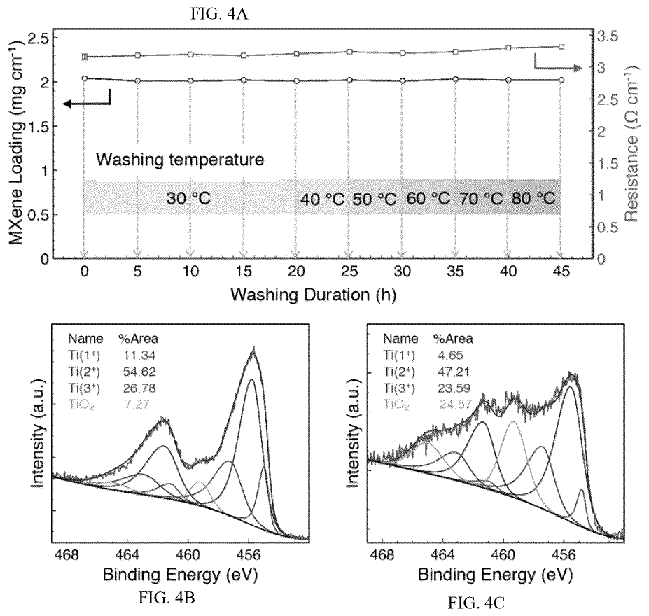

The ability of conducting fibers to withstand prolonged exposure to aqueous environments is critical for use in wearable applications. The impact of washing was studied using Ti₃C₂-coated cotton yarns produced by the two-step dip-coating process. S—Ti₃C₂ MXene was used to coat the individual fibers in the internal yarn structure, then L-Ti₃C₂ MXene was used to coat the external yarn surface. The outer MXene coating thickness on the yarn surface was 15.2±0.8 μm based on the cross-sectional SEM images. The MXene loading remained relatively unchanged (<1% decrease) after 45 hours of washing cycles at temperatures ranging from 30° C. to 80° C., as shown in FIG. 4A. This is due to the strong interactions between MXene flakes so that even vigorous shaking did not redisperse the flakes as shown in free-standing films.

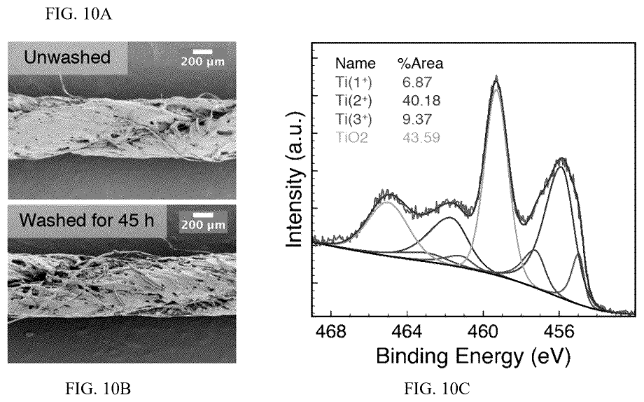

MXene-coated cotton yarns showed minimal change in linear electrical resistance after 20 washing cycles at 30° C. As the washing temperature increased from 30° C. to 80° C., the linear resistance increased only by ˜3%. SEM images of the unwashed (FIG. 10A) and washed (FIG. 10B) MXene-coated cotton yarns after 45 washing cycles revealed very little material loss even after 45 h at elevated temperature in water. The washed MXene-coated cotton yarns demonstrated similar mechanical properties to the unwashed MXene-coated yarns with tensile strength of 460.1±25.2 MPa, Young's modulus of 4.8±0.2 GPa, and failure at strain value of 0.0844±0.004. This result is the first to demonstrate the negligible detrimental effect of washing MXene-coated yarns on their mechanical properties.

X-ray photoelectron spectroscopy (XPS) was used to investigate if the washing process resulted in oxidation or degradation of MXene. XPS is inherently a surface sensitive technique due to the shallow escape depth of the photoelectrons generated from the material, therefore, the spectra gathered are indicative of only the outer <15 nm surface layer. FIG. 4B showed that the MXene in the unwashed fibers exhibited very low degree of oxidation whereby ˜7.3 at % of Ti in MXene was in the form of Ti⁴⁺ (indicative of TiO₂) which is the product of Ti₃C₂ MXene oxidation. After washing the yarns at 30° C. for 20 washing cycles followed by 25 washing cycles from 40 to 80° C., the MXene in the thin outer surface layer was oxidized with the Ti⁴⁺ comprising ˜43.6 at % (FIG. 10C). After sputtering for just 3 mins, the measured degree of oxidation decreased to ˜24.6 at % (FIG. 4C). Bulk properties, such as electrical conductivity, are often governed by the overall state of the material. The resistance of the MXene-coated cotton yarn increased by less than 5% after washing at temperatures ranging from 30° C. to 80° C. for 45 washing cycles, as shown in FIG. 4A. Partial surface oxidation (<1 μm in thickness compared to ˜15.2 μm in thickness of the external MXene layer) does not seem to significantly affect the overall conductivity of the yarns. The remaining MXene flakes in both the fiber and the yarn levels are able to provide similar conductivity values to unwashed MXene-coated cotton yarn. The summary of the high-resolution Ti₂p XPS region is provided in Table 1 herein for unwashed and washed MXene-coated cotton yarns before and after sputtering. These results further support our findings of the stability of MXene-coated cotton yarns under harsh environments. Unlike the colloidal MXene dispersions, once the MXene flakes are assembled and dried, there are no more reactive pathways for oxidation because additional water cannot easily rehydrate the structure. As a result, the exposure to water and temperature does not seem to affect the overall electrical conductivity of the MXene-coated cotton yarns as observed in case of assembled MXene flakes in films.

### Electrochemical Properties of MXene-Coated Cotton Yarns

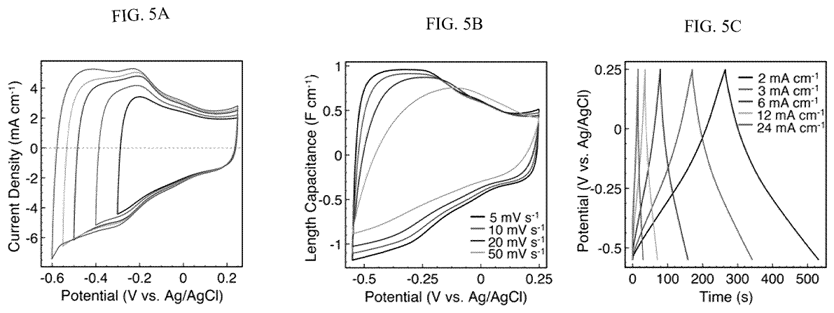

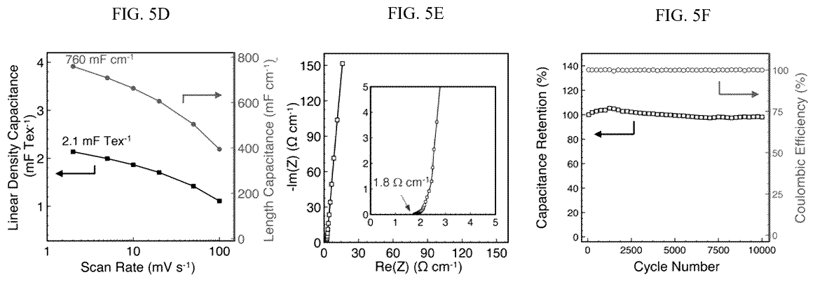

Electrochemical performance of MXene-coated cotton yarns was evaluated using a standard three-electrode set-up with 1 M H₂SO₄ electrolyte to assess the feasibility of using these yarns for energy storage applications. Cotton yarn with 78 wt. % (2.5 mg/cm) of MXene loading was used as the working electrode without any current collector during the test. Using cyclic voltammetry (CV), the stable potential range for the MXene-coated cotton yarns was identified to be between −0.55 and 0.25 V versus Ag/AgCl (FIG. 5A). The representative CV and galvanostatic charge-discharge (GCD) curves of the MXene-coated cotton yarns at different scan rates and current densities were shown in FIGS. 5b and 5c, respectively. The CV curves demonstrated a quasi-rectangular shape with close to ˜100% Coulombic efficiency under anodic potential at all scan rates indicating the capacitive behavior of MXene-coated cotton yarns. An increased capacitance under high cathodic potentials is due to H⁺ induced redox behavior of Ti₃C₂ (pseudo-capacitance). The GCD curves at different current densities, are highly symmetrical even at high discharge current density of 24 mA/cm. The specific capacitances as a function of scan rates were determined using CV curves as shown in FIG. 5D. The specific capacitance decay as a function of scan rate was most likely to be due to the diffusion limitations of the ionic transport. Similar intercalation/deintercalation rate limitation was also observed in case of thick planar MXene electrodes. The MXene-coated cotton yarn displayed a length capacitance (C_{L}) of ˜759.5 mF/cm at 2 mV/s. The areal capacitance (C_{A}) and volumetric capacitance (C_{V}) values were also calculated from CV curves at 2 mV/s as ˜3965.0 mF/cm² and ˜260.0 mF/cm³, respectively. Gravimetric capacitance (CG) is dependent on the thickness and density of the electrodes as well as weight of the other components, which results in unreliable comparison between different supercapacitors. However, mass is an important parameter and cannot be neglected. Both the gravimetric (mass) and the linear, areal, or volumetric capacitances need to be considered when evaluating the capacitance performance. Tex, mass of the yarn in grams per 1,000 meter, is a common metric used in the textile industry. It takes into consideration both the mass and the length of the yarns to avoid the faulty assumption of yarns being perfect cylinders with fixed diameters. The linear density of the cotton yarns at 2.5 mg/cm MXene loading (mass of the pristine cotton yarn ˜0.7 mg/cm) was measured as 320 Tex. Thus, the linear density capacitance of the electrode (C_{Tex}) was 2.1 mF/Tex at 2 mV/s. To the best of authors' knowledge, the cotton yarns with 78 wt. % MXene loading exhibited the highest specific length capacitance among the cellulose-based yarn-shaped supercapacitors reported to date.

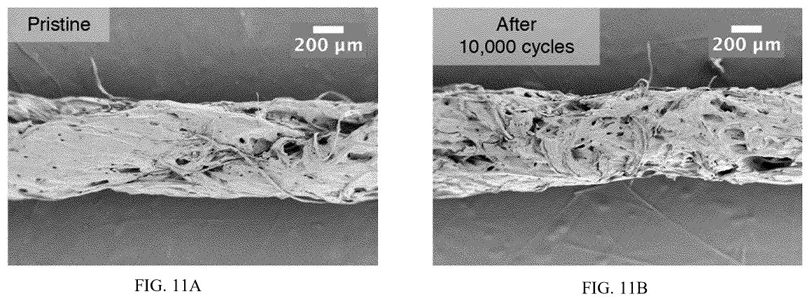

Electrochemical impedance spectroscopy (EIS) was conducted to understand the charge transfer and ion transport properties of the MXene-coated cotton yarns. As shown in FIG. 5E, the equivalent series resistance (ESR) was calculated as 1.8 Ω/cm from the high frequency intercept of the Nyquist plot. MXene-coated cotton yarns showed a short Warburg region with a 45° angle, which indicated good ion diffusion efficiency, and a linear behavior in the low-frequency region, demonstrating close to the ideal capacitive behavior. As shown in FIG. 5F, MXene-coated cotton yarns exhibited excellent cyclic stability with 100% Coulombic efficiency after 10,000 cycles at a current density of 30 mA/cm. It should be noted that the MXene coated cotton yarn electrode has not been precycled prior to the cyclability test and the ˜5% increase in capacitance stabilized back to 100% retention after ˜2,000 cycles. This result shows that for practical applications, the textile supercapacitors built using MXene-coated cotton electrodes need to be preconditioned prior to use. SEM images (FIG. 11) of the MXene-coated cotton yarns before and after 10,000 cycles show that the morphology of the yarns as well as the MXene coating remained almost unchanged.

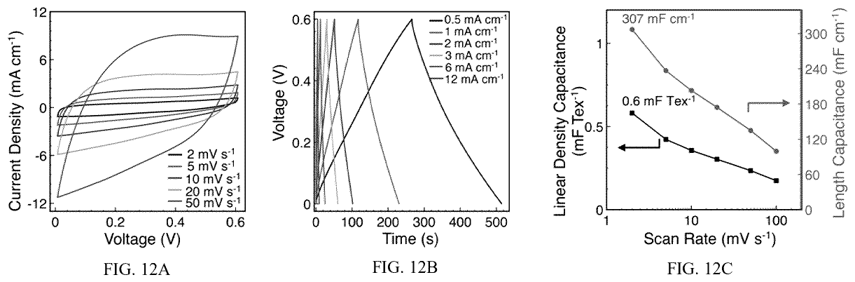

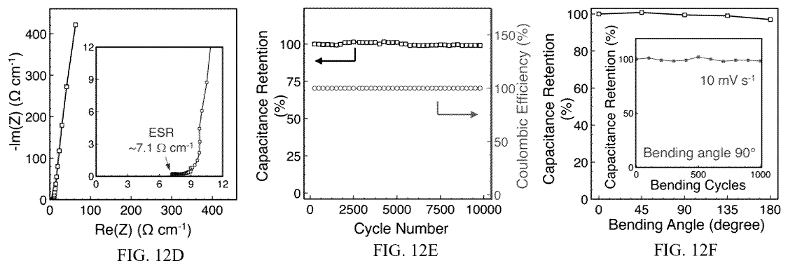

The electrochemical results indicate that MXene-coated cotton yarns can be a potential candidate in powering wearable electronics. They can be incorporated into symmetric yarn supercapacitors to offer sufficient energy and power for a variety of applications. To demonstrate this, yarn supercapacitors were fabricated using a symmetric device configuration where both of the electrodes had the same amount of MXene loading. The electrodes were separated by a polyvinyl alcohol (PVA)—H₂SO₄ gel electrolyte. The voltage window was kept at 0.6 V to prevent the oxidation of Ti₃C₂ MXene as suggested by previous studies. From the CV curves shown in FIG. 12A, the specific capacitance values of the device (at 2 mV/s) were calculated as C_{L} of ˜306.9 mF/cm (0.6 mF/Tex), C_{A} of ˜1865.3 mF/cm², and C_{V} of ˜142.4 mF/cm³. The GCD curves (FIG. 12B) are highly symmetric at all current densities investigated with negligible iR drop. The rate handling of the symmetric yarn supercapacitor device shown in FIG. 12B can be adjusted by using a yarn electrode with smaller diameter, which would reduce the overall thickness of the device and improve the ion diffusion at higher scan rates. The Nyquist plot (FIG. 12D) showed nearly vertical behavior at all frequencies, suggesting fast ion diffusion with an estimated ESR value of 7.1 Ω/cm. The yarn supercapacitor device showed a long-term capacitance retention of ˜100% after 10,000 charge-discharge cycles while maintaining 100% Coulombic efficiency (FIG. 12E) when tested with GCD cycles at 5 mA/cm. Further increase in the voltage window and energy storage can be achieved by using organic electrolyte. The stability and performance of free-standing yarn supercapacitor devices (5 cm long) were also tested under bending cycles at various bending angles as shown in FIG. 12F. The device demonstrated stable response with a ˜100% capacitance retention after 1,000 cycles when bent at 90°. The performance of the device remained stable when repeated deformations were applied during the test.

### Knitted Capacitive Pressure Sensor Device

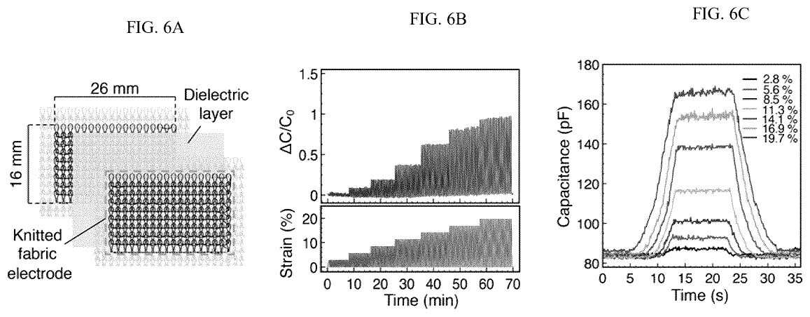

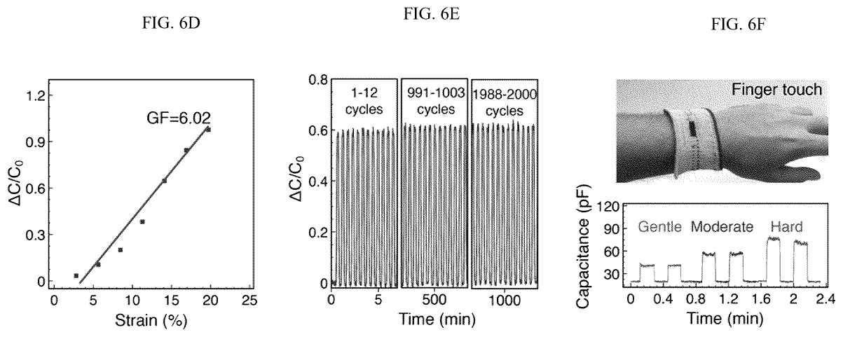

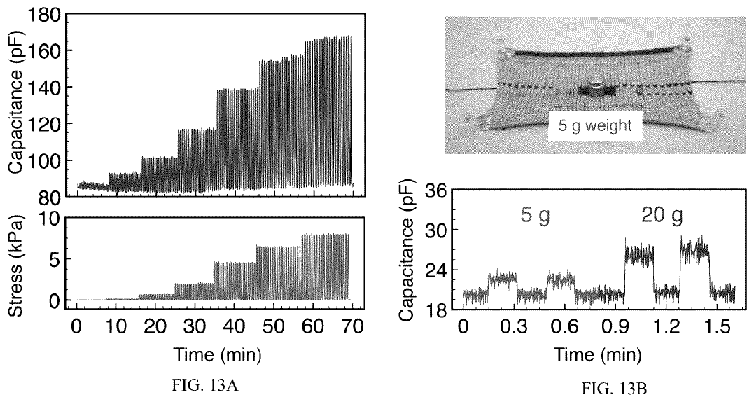

To demonstrate multifunctionality of MXene-coated yarns, we also used them to make a textile pressure sensor device. Since MXene-coated cotton yarns were used to demonstrate the feasibility of energy storage applications, MXene-coated bamboo yarns have been chosen for the pressure sensor device assembly. We knitted MXene-coated bamboo yarns (MXene loading 0.6 mg/cm) into a rectangular swatch (16 mm by 26 mm) surrounded by a knitted viscose yarn using interlock stitch (FIG. 6A). The capacitive textile sensor device was then prepared by carefully placing two identical knitted swatches on top of each other with a dielectric layer of thin nitrile rubber sandwiched in between. The electromechanical measurement of the textile sensor showed that the capacitance (C) increased with compression strain (FIG. 6B) and applied stress (FIG. 13A), and returned to initial value (C₀) when released. The capacitance response of the sensor as a function of various magnitudes of cyclic compression strains (FIG. 6C) showed that the textile sensor was able to respond to a wide range of compression strains (ε) from 2.8% to 19.7%, equivalent to pressures of 0.002 and 66 kPa (per whole sensor area, not considering textile porosity), respectively. Notably, the relative change in capacitance (ΔC/C₀) showed a linear relationship with the magnitude of compression strain, indicating the linearity of the sensing response (FIG. 6D). Fitting a linear line to ΔC/C₀ vs. ε data, revealed a slope of 6.02. This slope corresponds to the gauge factor (GF) of the sensor, defined as ΔC/εC₀. GF is an important sensing metric as it determines the sensitivity of the sensor device. This GF is comparable to other capacitive textile-based pressure sensors, indicating the high sensitivity of the knitted MXene-coated yarn pressure sensor device. When repeatedly compressed and relaxed for 2,000 cycles at 14.1% strain, the capacitive response of the textile device remained constant (FIG. 6E), indicating excellent cyclic stability. This long-term sensing stability demonstrates that the sensor's response is reproducible.

We also prepared a capacitive pressure sensor button (FIG. 6F) by knitting the MXene-coated yarn into fully functional device, i.e. two textile electrodes and a sandwiched dielectric layer, in one step using an industrial-scale knitting machine. The knitted pressure sensor button was capable of sensing various levels of finger pressures and weights. For instance, the capacitance response of the sensor increased approximately two, three, and four times its initial value when gentle, moderate, and hard pressures were applied, respectively (FIG. 6F). Moreover, 20% and 50% increases in the capacitance response were observed when 5 g and 20 g weights were placed on the textile device, respectively (FIG. 13B). These examples show that the knitted fabric sensor is capable of distinguishing various levels of applied pressures and can may be used in practical applications. The performance of the knitted pressure sensor can be further improved in the future by changing the yarn type, stitch pattern, active material loading, and the dielectric layer to result in higher capacitance changes under applied pressure to achieve more reliable devices for wearable applications.

This work introduced a simple two-step dip-coating process using colloidal solutions of small- and large-size Ti₃C₂ MXene flakes, which transformed traditional cellulose-based yarns into highly conductive, electrochemically and electromechanically active yarns. MXene loadings of up to 77 wt. % (2.2 mg/cm) were achieved, which resulted in yarns with a remarkable electrical conductivity of up to 440.3±0.9 S/cm. By adjusting the stitch pattern between single jersey, half-gauge and interlock, MXene-coated cellulose-based yarns were successfully knitted into full fabrics using an industrial knitting machine. When washed at temperatures ranging from 30° C. to 80° C., the MXene loading remained almost unchanged with negligible change in the yarn resistance and conductivity. The MXene-coated cotton yarn exhibited a high length capacitance (C_{L}) of up to 759.5 mF/cm (2.1 mF/Tex). The C_{L} of 306.9 mF/cm (0.5 mF/Tex) at 2 mV/s was achieved when two MXene-coated cotton yarns were assembled into free-standing, symmetric yarn supercapacitor. By using the knitted MXene-coated bamboo yarns as electrodes, we achieved a textile-based capacitive pressure sensor that demonstrated a high sensitivity (GF˜6.02), a sensing range of 20% compression, and excellent cycling stability at ˜14.1% strain for 2,000 cycles. The MXene-coated yarns offer suitable properties that can meet the performance requirements of applications other than energy storage and sensing, such as triboelectric energy harvesting, EMI shielding, and heated fabrics. The established approach in this study, which combines the versatile chemistry and promising electrical and electrochemical properties of MXenes with the existing cellulose-based yarns, offers a platform technology for various textile-based devices by allowing tunability in performance for the building blocks of textiles.

### Experimental Section

Synthesis of Ti₃C₂Tₓ MXene: Ti₃AlC₂ MAX phase powder was synthesized according to the method described previously. Ti₃C₂ was synthesized by selective etching of Al atomic layers from Ti₃AlC₂ MAX phase. To prepare the MXene dispersion, 3 g of Ti₃AlC₂ was added slowly to a 60 mL of chemical etchant (6:3:1 ratio) consisting of 36 mL of 12 M hydrochloric acid (HCl, Alfa Aesar, 98.5%), 18 mL of deionized (DI) water, and 6 mL of hydrofluoric acid (HF, Acros Organics, 49.5 wt. %). The mixture was stirred at 500 rpm for 24 h at room temperature. After etching, the solution was washed by repeated centrifugation at 3,500 rpm for 5 min cycles. The acidic supernatant was decanted after centrifuging and DI water was then added to wash the MXene powder several times until its pH reached ˜5-6.

Delamination and preparation of MXene: For delamination, 2 g of lithium chloride (LiCl, Chem-Impex Int., 99.3%) dissolved in 100 mL of DI water was added to the sediment after washing. The lithium-ions intercalate between the interlayer spacings of multilayered MXene to facilitate subsequent delamination into few layered sheets. The mixture was first dispersed by manual shaking and then stirred at room temperature for 4 hours. The MXene solution was then washed four times by centrifugation until the supernatant was dark, indicating delamination. To separate unreacted Ti₃AlC₂ MAX and multi-layer Ti₃C₂ MXene flakes, centrifugation at 3,500 rpm for 5 min was repeated. The supernatant was collected, and the sediment was redispersed with more water before beginning the next centrifuge cycle. The concentration of the MXene dispersion was measured by vacuum filtration of a known volume of solution and measuring the mass of the resulting free-standing film. To increase the concentration, the MXene dispersion was centrifuged at 9,000 rpm for 2 hours, the clear supernatant was decanted, and the sediment was redispersed in a known volume of DI water. The new concentration of the MXene dispersion, also called as-synthesized MXene, was measured again before being used for dip-coating. Half of the as-synthesized MXene dispersion was probe sonicated (Fisher Scientific model 505 Sonic Dismembrator, 500 W) for 20 min under a pulse setting (8 s on pulse and 2 s off pulse) at an amplitude of 50%. The MXene dispersion in a 50 mL glass bottle was inserted in an ice bath to keep the dispersion cool during sonication.

Characterization: The flake size distributions and the zeta potential measurements of the MXene dispersions were conducted using dynamic light scattering (DLS). Diluted MXene dispersion was transferred into a polystyrene cuvette (Zetasizer Nano ZS, Malvern Instruments, USA), and a total of five measurements from each sample were taken for the DLS average. The weight of the yarn was measured using a scale (Mettler Toledo, Columbus, OH) before and after dip-coating to determine the MXene loading. Scanning electron microscopy (SEM) images were taken on a Zeiss Supra 50 VP with an accelerating voltage of 3 kV to observe the MXene coating on the individual fibers and the yarn surface. Yarn cross-sections were obtained by submerging the yarn in liquid nitrogen and then manually breaking the frozen yarn. X-ray diffraction (XRD) was conducted to study the structure of the precursor Ti₃AlC₂ MAX, Ti₃C₂ MXene film, pristine cotton and MXene-coated cotton yarn. A Rigaku Miniflex II-Gen. 6 (Rigaku Co. Ltd. USA) with Cu K_{α} (λ=0.1542 nm) source and graphite K_{β} filter was used for measurements and the spectra were acquired at 40 kV voltage and 15 mA current for 2-theta values from 2 to 65 degrees. AFM measurements were done using a NX-10 (Park Systems, Korea) in a standard tapping mode in air. The drive frequency was 272 kHz. The image was collected at 15 by 15 μm scan size at a scan rate of 0.3 Hz. AFM samples were prepared by spin-coated MXene solutions on Si/SiO₂ (300 nm) at 3000 rpm for 60 s. The substrates were then dried at 7000 rpm for 15 s. X-ray photoelectron spectroscopy (XPS) was conducted using PHI VersaProbe 5,000 instrument (Physical Electronics, USA) with a 200 μm and 50 W monochromatic Al-K_{α} (1486.6 eV) X-ray source. Charge neutralization was accomplished through a dual beam setup using low energy Ar⁺ ions and low energy electrons at 1 eV/200 μA. Sputtering on 2×2 mm² area was conducted using Art-ion source at 4 kV accelerating voltage and 5 mA cm-2 current density for up to 3 minutes. High-resolution Ti-2p region spectra were collected using pass energy and energy resolution of 23.5 eV and 0.05 eV, respectively. No binding energy scale correction was applied as the samples were conducting, charge neutralization was adequate, and no irregular shifts in the spectra were observed even after sputtering. Quantification and peak fitting were conducted using CasaXPS V2.3.19. Mixed Gaussian-Lorentzian, GL (30), peak shape was used for oxygen related moieties (TiO₂), and asymmetric Lorentzian, LA(2,4,6), was used for metal related moieties (Ti—C, Ti—O, Ti—F).

The electrical resistance of the MXene-coated yarns was measured using a two-point probe with Keysight 2400 multimeter by repeating the test on at least ten different positions. The diameter of the yarns was measured using an Olympus PMG 3 (Olympus, Center Valley, PA) optical microscope from an average of ten different locations along the yarn length. Conductivity (σ) was calculated by σ=I/RA_{C}, where I, R, and Ac are the length, resistance, and the cross-sectional area of the yarn, respectively. The mechanical properties of the MXene-coated cellulose-based yarns were analyzed using a DHR-3 (TA Instruments, DE) rheometer with a 50 N load cell and crosshead speed of 1.5 mm/min. Samples were prepared by attaching the yarn vertically onto a rectangular paper frame with 25 mm gauge length. After mounting the frame on the grips, the paper was cut in the middle and the yarn was stretched at a strain rate of 0.001/s (6%/min) until failure.

Knitting: The MXene-coated cellulose-based yarns were knitted using a 15-gauge, SWG041N Shima Seiki computerized knitting machine. The Apex-3 Design software was used to program knitted devices and samples. Rectangular swatches were knitted using interlock and half-gauge stitch patterns. The pressure sensor button was fully knitted from start to finish using MXene-coated bamboo yarns (0.6 mg/cm MXene loading) as the electrode material. The sensor consists of two electrodes that were independently knitted on two separate planes (front surface and back surface). Two individual feeders, each carrying a MXene-coated bamboo yarn, were used to simultaneously knit the two independent fabric electrodes with reflective symmetry. A key consideration was to avoid contact between the two electrodes to prevent short circuiting. This was achieved by carefully designing the knitting program. After knitting of active material was completed, the machine signalled a programmed stop. The dielectric layer (nitrile rubber) was then carefully placed between the fabric electrodes and the pocket was closed by knitting a commercial viscose yarn on the subsequent row, securing the dielectric layer.

Washability: MXene-coated cotton yarns were washed with 1 mg/mL Synthrapol solution, where they were loosely secured onto a mesh to prevent tangling during the washing process. Synthrapol is a mild detergent commonly used in yarn and fabric dyeing, which facilitates removing loose dye particles from the substrate. The MXene-coated cotton yarns fixed to the mesh were placed into a vial with the Synthrapol and stirred at 500 rpm, where the mesh was free to move during stirring. Two sets of 100 cm long MXene-coated cotton yarns were washed for 20 washing cycles (60 min stirring for each cycle at 500 rpm) at 30° C. Then, the same yarns (washed at 30° C. for 20 washing cycles) were further washed 5 more cycles at each listed temperature consecutively: 40° C., 50° C., 60° C., 70° C., and 80° C. As a result, the yarns were washed 45 washing cycles in total. For each set of yarns, the MXene loading and the linear resistance along ten ˜1 cm long yarn segments were measured and compared. Next, the yarns were rinsed with deionized water (DI) and air dried at room temperature for at least 6 h and then dried in a vacuum desiccator for 4 h prior to measuring the mass loss and linear resistance.

Fabrication of yarn electrodes: The electrochemical properties of the MXene-coated cotton yarns were studied in a three-electrode configuration. The counter and the reference electrodes were graphite rod and Ag/AgCl (3 M KCl), respectively and 1 M H₂SO₄ was used as the electrolyte. The working electrode was prepared by attaching a ˜25-30 mm long MXene-coated cotton yarn (2.5 mg/cm of MXene loading) to the end of a fine silver wire using conductive silver paste. The connection and the silver wire were sealed using epoxy glue to avoid contact of silver paste with the electrolyte.

Fabrication of yarn supercapacitor devices (YSC): For the yarn supercapacitor (YSC) device, PVA-H₂SO₄ gel electrolyte was prepared by dissolving 3 g of PVA powder (Sigma-Aldrich, MW=89,000-98,000) in 30 mL of water at 85° C. under vigorous stirring. 3 g of sulfuric acid (98 wt. %, H₂SO₄, Fisher Chemical) was added to the PVA solution after it cooled down to room temperature and a homogenous gel was achieved. For preparation of YSCs, MXene-coated cotton yarns (length of each yarn ˜60 mm) were immersed in the PVA-H₂SO₄ gel electrolyte for ˜10 mins and dried in air overnight. The YSC device was prepared in parallel configuration by placing two MXene-coated cotton yarn electrodes next to each other and coating twice with PVA-H₂SO₄ gel electrolyte to ensure a complete coating.

Characterization of yarn electrodes and YSC: Cyclic voltammetry (CV), galvanostatic charge-discharge (GCD), and electrochemical impedance spectroscopy (EIS) were performed using an electrochemical workstation (VMP 3, BioLogic, France) at room temperature. Yarn electrodes and devices were pre-cycled using CV at 100 mV/s for 20 cycles prior to recording the electrochemical data. The current density values extracted in the CV and GCD curves were normalized to the length of the yarn electrode. For the three-electrode setup, CV and GCD curves were recorded at a potential window of 0.25 to −0.55 V (vs. Ag/AgCl) at the scan rates ranging from 2 to 100 mV/s and at the specific current per length of 2 to 24 mA/cm, respectively. For the two-electrode setup, CV and GCD curves were recorded in a voltage window of 0 to 0.6 V at the scan rates ranging from 2 to 100 mV/s and at the specific current per length of 0.5 to 12 mA/cm. The electrochemical impedance spectroscopy (EIS) was performed at open-circuit potential within a frequency range from 1 mHz to 1 MHz at an alternating-current voltage with 10 mV amplitude. Cycling stability was measured by repeating the GCD test for 10,000 cycles at a current density of 30 mA/cm and 5 mA/cm for three-electrode and two-electrode setups, respectively.

The capacitance was calculated by integrating the discharge portion of the CV data using the following equation:

$${C}_{D} = \frac{{\int }_{0}^{t} id V}{v Δ V} \qquad ( 1 )$$

where i is the instantaneous current at the potential of V, υ is the scan rate (V/s), and ΔV is the potential/voltage window (V). The numerator of the equation is the integral of the discharge portion of the CV curve. The length (C_{L}, mF/cm), areal (C_{A}, mF/cm²), volumetric (C_{V}, F/cm³), and linear density (C_{Tex}, mF/Tex) specific capacitances of the electrode were obtained by normalizing the capacitance to the length, outer surface area, volume, and the linear density (Tex) of the yarn electrode respectively (for three-electrode configuration). The specific capacitances of the supercapacitor device were calculated by normalizing the capacitance to the length of the whole device, total area, total volume, and the total linear density of the device, respectively (including both electrodes with same length).

The outer surface area (A) and volume (V) of the yarn electrode were calculated using the following equations:

$$\text{Area:} A = 2 π rl , \qquad ( 2 )$$

$$\text{Volume:} V = π {r}^{2} l , \qquad ( 3 )$$

where l denotes the length of the electrode, r is the radius of the yarn electrode. The capacitance retention (C_{Ret}) of the electrode and the YSC device were calculated from the specific capacitance in the first cycle (C₁) and the specific capacitance after the cycle number i, using the following equation:

$${C}_{Ret} = \frac{{c}_{i}}{{c}_{1}} \times 100 \% \qquad ( 4 )$$

Characterization of the pressure sensor: The pressure sensing properties of the knitted samples were measured by real-time monitoring of the capacitance response during the cyclic compression-relaxation tests. Synchronized mechanical and electrical (electromechanical) data were collected using an Instron 3300 (Model 3365, Norwood, MA) with a 100 N load cell at a crosshead speed of 5 mm/min and a multimeter (Model 34461A, Keysight, Santa Rosa, CA). Dimensions of each electrode used for the electromechanical test were 60 mm×65 mm in total area and 16 mm×26 mm in active area with a dielectric thickness of ˜72 μm and a total sensor thickness of ˜2.5 mm. The active area of the pressure sensor was knitted using MXene-coated bamboo yarns with 0.6 mg/cm MXene loading. The surrounding textile was knitted using a commercial viscose yarn (70 Tex). Relative capacitance change (ΔC/C₀) was calculated, which represents capacitance (C) at each point normalized in respect to the initial capacitance (C₀).

### Additional Disclosure

### Knittable and Washable Multifunctional MXene-Coated Cellulose Yarns

The XRD pattern of the Ti₃C₂ MXene film is characterized by the (001) family of planes, defined by the interlayer spacing, where l=2, 4, 6, 8, 10, . . . . These reflections correspond to the out-of-plane stacking of single layer MXene flakes. The asterisk (*) indicates a second layer of intercalated water within the structure. XRD pattern of pristine cotton yarn demonstrates the cellulose peak at 20=23.2° corresponds to (002) reflection.^{[59]} Because of the relatively good in-plane alignment of flakes in the vacuum filtered Ti₃C₂ film, peaks corresponding to the basal direction are broad, but well resolved. However, in the MXene-coated cotton yarn, the flakes are randomly oriented hence new peaks appear, including those for vertically aligned flakes. According to Ghidiu et al. the peaks at 2θ=61° and 2θ=35°/37° correspond to (110) and (011)/(010) reflections, respectively, while the broad peak at 2θ=41.5° corresponds to the (016) Ti₃C₂ reflection.^{[60]} In general, the high intensity between 3° and 10° indicates that MXene is homogenously dispersed throughout the cotton material as there is a wide distribution of the interlayer spacings.

TABLE 1
Summary of the high-resolution Ti2p XPS region fittings of unwashed
and washed MXene-coated cotton yarns before sputtering and after 3
min sputtering, shown in FIG. 4B, FIG. 10C, and FIG. 4C, respectively.

| | | | | Washed | | | Washed | | |
|---|---|---|---|---|---|---|---|---|---|
| | Unwashed | | | No Sputtering | | | 3 min Sputtering | | |
| Name | Pos. | FWHM | % Area | Pos. | FWHM | % Area | Pos. | FWHM | % Area |
| Ti(1+) 3/2 | 454.96 | 0.69 | 7.56 | 454.96 | 0.64 | 4.58 | 454.79 | 0.58 | 3.10 |
| Ti(1+) 1/2 | 461.16 | 1.39 | 3.78 | 461.16 | 1.41 | 2.29 | 460.99 | 1.32 | 1.55 |
| Ti(2+) 3/2 | 455.75 | 1.51 | 36.42 | 455.86 | 1.52 | 26.79 | 455.50 | 1.74 | 31.48 |
| Ti(2+) 1/2 | 461.55 | 2.10 | 18.20 | 461.66 | 2.09 | 13.39 | 461.30 | 1.78 | 15.73 |
| Ti(3+) 3/2 | 457.20 | 1.86 | 17.86 | 457.23 | 1.17 | 6.25 | 457.38 | 1.78 | 15.73 |
| Ti(3+) 1/2 | 462.90 | 2.50 | 8.92 | 462.93 | 2.50 | 3.12 | 463.08 | 1.98 | 7.86 |
| TiO₂ 3/2 | 459.20 | 1.50 | 4.85 | 459.30 | 1.45 | 29.07 | 459.30 | 2.00 | 16.38 |
| TiO₂ 1/2 | 464.90 | 2.50 | 2.42 | 465.00 | 2.50 | 14.52 | 465.00 | 2.50 | 8.19 |

### EXAMPLE EMBODIMENTS

The following embodiments are exemplary only and do not serve to limit the scope of the present disclosure or of the appended claims.

Embodiment 1. A conductive fiber, comprising: a substrate fiber, the substrate fiber defining an outer surface coated with a first plurality of MXene particulates.

Embodiment 2. The conductive fiber of Embodiment 1, wherein the substrate fiber comprises a naturally occurring material. Cotton, linen, silk, wool, cashmere, hemp, jute, angora, and blends are examples of natural fibers; cotton, linen, and silk are considered especially suitable.

Embodiment 3. The conductive fiber of Embodiment 1, wherein the substrate fiber comprises a synthetic material. Nylon, polyester, acrylic, aramid, modal, carbon, glass, rayon, elastomer fibers (e.g., polyurethane, olefin fibers such as polypropylene and polyethylene, and blends) are all exemplary synthetic fibers. Nylon, polyester, carbon, and glass fibers are considered especially suitable.

Embodiment 4. The conductive fiber of Embodiment 1, wherein the first plurality of MXene particulates has an average particle size in the range of from about 100 to about 1000 nm, e.g., from about 100 to about 1000 nm, from about 200 to about 900 nm, from about 300 to about 800 nm, from about 400 to about 700 nm, or even from about 500 to about 600 nm. The average particle size of the MXenes can be selected such that it is smaller than the diameter of the fibers onto which the MXenes are coated. As an example, the MXene particles used with cotton fibers having an average diameter of 20 micron can be smaller than the fibers with an average diameter of 50 micron.

As another example, in the case of cotton, bamboo, and linen fibers, the average flake size was around 300 nm to coat the fibers, which is the most likely size range for MXene particles to coat fibers in the commercial embodiment.

Embodiment 5. The conductive fiber of any one of Embodiments 1-4, wherein the first plurality of MXene particulates comprises two different MXene materials. The different MXene materials can differ in terms of their size, in terms of their composition, or in terms of their size and composition.

Embodiment 6. The conductive fiber of any one of Embodiments 1-5, wherein the first plurality of MXene particulates defines a unimodal particle size distribution.

Embodiment 7. The conductive fiber of any one of Embodiments 1-5, wherein the first plurality of MXene particulates defines a multimodal particle size distribution.

Embodiment 8. The conductive fiber of any one of Embodiments 1-5, wherein the first plurality of MXene particulates are attached to the substrate fiber by electrostatic interaction. In the case of synthetic yarns, the fiber surface can be functionalized using plasma cleaner or chemical etchants to ensure the MXene adhesion to the fiber surface. For natural fibers, there is no need for any processing prior to the coating, it is purely due to electrostatic interactions.

Embodiment 9. A yarn, comprising: a plurality of conductive fibers according to any one of Embodiments 1-8. It should be understood that a yarn can comprise fibers that differ from one another in size, composition, or both. A yarn can, for example, comprise natural fibers and synthetic fibers.

Embodiment 10. The yarn of Embodiment 9, the yarn defining an outer surface coated with a second plurality of MXene particulates.

Embodiment 11. The yarn of Embodiment 10, wherein the second plurality of MXene particulates has an average particle size in the range of from about 500 to about 15,000 nm, e.g., from about 700 to about 12,000 nm, or from about 1,000 to about 10,000 nm, or from about 1,500 to about 7,500 nm, or even from about 2,500 to about 6,500 nm. MXene particulates (which can be, e.g., flakes in configuration) can have an average particle size of from about 1000 to about 3000 nm.

Embodiment 12. The yarn of any one of Embodiments 9-11, wherein the second plurality of MXene particulates comprises two different MXene materials. The MXene materials can differ in terms of size, in terms of composition, or both.

Embodiment 13. The yarn of any one of Embodiments 9-12, wherein the second plurality of MXene particulates defines a unimodal particle size distribution.

Embodiment 14. The yarn of any one of Embodiments 9-12, wherein the first plurality of MXene particulates defines a multimodal particle size distribution.

Embodiment 15. The yarn of any one of Embodiments 9-14, wherein the second plurality of MXene particulates are attached to the outer surface of the yarn by electrostatic interaction.

Embodiment 16. The yarn of Embodiment 9, wherein the yarn is characterized as having a MXene loading of from about 0.1 to about 2.0 mg/cm.

MXene loading at the level of fibers can depend on the number of dips used to coat the fibers. (Single- or multi-dip processes can be used.) The loading can depend on the requirements of the application. For example, sensor applications may not in all cases require highly conductive yarns, and can thus MXene loading of 0.6-1.0 mg/cm would be sufficient. On the other hand, for supercapacitor applications, capacitance is directly correlated to MXene loading, so higher the MXene loading (e.g. >2.0 mg/cm), the higher the specific capacitance of the device.

Embodiment 17. The yarn of Embodiment 9, wherein the yarn is characterized as having a MXene mass loading of from about 10 to about 75 wt %, or from about 15 to about 70 wt %, or from about 20 to about 65 wt %, or from about 30 to about 55 wt %, or even about 40 wt %.

Embodiment 18. The yarn of Embodiment 9, wherein the yarn is characterized as having a conductivity of from about 30 to about 150 S/cm.

Embodiment 19. The yarn of any one of Embodiments 10-15, wherein the yarn is characterized as having a MXene loading of from about 2.0 to about 3.0 mg/cm.

Embodiment 20. The yarn of any one of Embodiments 10-15 or 19, wherein the yarn is characterized as having a MXene mass loading of from about 75 to about 85 wt %

Embodiment 21. The yarn of any one of Embodiments 10-15 or 19, wherein the yarn is characterized as having a conductivity of from about 200 to about 440 S/cm.

Embodiment 22. A yarn, comprising: a plurality of conductive fibers, the yarn defining an outer surface coated with a plurality of MXene particulates.

Embodiment 23. A method, comprising: forming a fiber according to any one of Embodiments 1-8.

Embodiment 24. A method, comprising: forming a yarn according to any one of Embodiments 9-22.

Embodiment 25. A knitted, woven, or non-woven fabric comprising a fiber according to any one of Embodiments 1-8, the knitted, woven, or non-woven fabric optionally being characterized as having a MXene loading level that changes by less than about 1% following washing for 20 h at 30 deg. C., 5 h at 40 deg. C., 5 h at 50 deg. C., 5 h at 60 deg. C., 5 h at 70 deg. C., and 5 h at 80 deg. C.

Embodiment 26. A knitted, woven, or non-woven fabric comprising a yarn according to any one of Embodiments 9-22, the knitted, woven, or non-woven fabric optionally being characterized as having a MXene loading level that changes by less than about 1% following washing for 20 h at 30 deg. C., 5 h at 40 deg. C., 5 h at 50 deg. C., 5 h at 60 deg. C., 5 h at 70 deg. C., and 5 h at 80 deg. C.).

Embodiment 27. A method, comprising: coating a plurality of substrate fibers with a first plurality of MXene particulates so as to form coated substrate fibers.

Embodiment 28. The method of Embodiment 27, wherein coating the plurality of substrate fibers comprises dip coating, inking, spraying, or any combination thereof. One can perform a single- or multiple-dip process. One can also apply a MXene ink to fibers or to yarn, e.g., by brushing, jetting, and other methods of application.

Embodiment 29. The method of any one of Embodiments 27-28, further comprising forming a yarn from the plurality of coated substrate fibers.

Embodiment 30. The method of Embodiment 29, further comprising coating the yarn with a second plurality of MXene particulates.

Embodiment 31. The method of Embodiment 30, wherein coating the yarn comprises dip coating, inking, spraying, or any combination thereof.

Embodiment 32. A device, the device comprising a fiber according to any one of Embodiments 1-8 or a yarn according to any one of Embodiments 9-22.

Embodiment 33. The device of Embodiment 32, wherein the device comprises a capacitor, an energy harvesting device, an antenna, a heater, an electromagnetic interference shield, or any combination thereof.

Embodiment 34. The device of Embodiment 32, wherein the device comprises an electrolyte contacting a fiber according to any one of Embodiments 1-8 or a yarn according to any one of Embodiments 9-22.

Embodiment 35. A pressure sensor, comprising: a first electrode; a second electrode; and a dielectric material disposed so as to place the first electrode into electrical isolation from the second electrode, at least one of the first electrode and the second electrode comprising (a) a substrate fiber, the substrate fiber defining an outer surface coated with a first plurality of MXene particulates, (b) a yarn comprising a plurality of coating fibers, each coating fiber comprising a substrate fiber defining an outer surface coated with a first plurality of MXene particulates, (c) a yarn comprising a plurality of coating fibers, each coating fiber comprising a substrate fiber defining an outer surface coated with a first plurality of MXene particulates and the yarn defining an outer surface coated with a second plurality of MXene particulates, or (d) a yarn comprising a plurality of fibers, the yarn defining an outer surface coated with a second plurality of MXene particulates.

The disclosed pressure sensors can be used in a variety of devices, e.g., touchscreen sensors, switches, capacitors, and the like. Touchscreen applications are especially suitable for the disclosed devices.

Embodiment 36. The pressure sensor of Embodiment 35, wherein at least one of the first electrode and the second electrode is characterized as being a woven fabric, a knitted fabric, or a nonwoven fabric.

Embodiment 37. The pressure sensor of any one of Embodiments 35-36, wherein a substrate fiber comprises a synthetic material. Suitable synthetic materials include, e.g., nylon, polyester, acrylic, aramid, modal, carbon, glass, rayon, elastomer fibers such as polyurethane, olefin fibers such as polypropylene and polyethylene, and blends thereof. Nylon, polyester, carbon, and glass fibers are especially suitable.

A substrate fiber can also comprise a natural fiber. Suitable natural fibers include, e.g., cotton, linen, silk, wool, cashmere, hemp, jute, angora, and blends thereof. Cotton, linen, and silk are especially suitable.

Embodiment 38. The pressure sensor of Embodiment 37, wherein the first plurality of MXene particulates has an average particle size in the range of from about 100 to about 1000 nm, e.g., from about 200 to about 800 nm, from about 300 to about 700 nm, or from about 400 to about 600 nm.

MXene particulate size can depend on the average fiber diameter that will be infiltrated with MXene. For example, the MXene particulates for fibers with an average diameter of 20 microns can be smaller than MXene particulates used with fibers having an average diameter of 50 micron.

In case of cotton, bamboo, and linen fibers, MXene particles can be around 300 nm in size, which size can coat fibers.

Embodiment 39. The pressure sensor of any one of Embodiments 35-38, wherein the first plurality of MXene particulates comprises two different MXene materials. The two MXene materials can differ in size, in composition, or both.

Embodiment 40. The pressure sensor of any one of Embodiments 35-39, wherein the first plurality of MXene particulates defines a unimodal particle size distribution.

Embodiment 41. The pressure sensor of any one of Embodiments 35-40, wherein the first plurality of MXene particulates defines a multimodal particle size distribution.

Embodiment 42. The pressure sensor of any one of Embodiments 35-41, wherein the first plurality of MXene particulates are attached to the substrate fiber by electrostatic interaction. In some embodiments, a fiber surface can be functionalized using plasma cleaner or chemical etchants to enhance MXene adhesion to the fiber surface. For natural fibers, it is not necessary to perform processing, as MXene particulates can secure to fibers due to electrostatic interactions.

Embodiment 43. The pressure sensor yarn of any one of Embodiment 35-42, wherein the second plurality of MXene particulates has an average particle size in the range of from about 500 to about 1500 nm, e.g., from about 500 to about 1500 nm, or from about 700 to about 1300 nm, or from about 900 to about 1100, or even about 1000 nm.

Embodiment 44. The pressure sensor of any one of Embodiments 35-43, wherein the second plurality of MXene particulates comprises two different MXene materials.

Embodiment 45. The pressure sensor of any one of Embodiments 35-44, wherein the second plurality of MXene particulates defines a unimodal particle size distribution.

Embodiment 46. The pressure sensor of any one of Embodiments 35-45, wherein the second plurality of MXene particulates are attached to the outer surface of the yarn by electrostatic interaction.

Embodiment 47. The pressure sensor of any one of Embodiments 35-46, wherein the yarn is characterized as having a MXene loading of from about 0.1 to about 2.0 mg/cm, or from about 0.3 to about 1.7 mg/cm, or even from about 0.7 to about 1.2 mg/cm.

The MXene loading can depend on the method by which the MXene is coated onto the fibers/yarn. As an example, MXene loading can depend on the number of dips in a dip coating process; the loading can be increased as the number of dips increases. A MXene loading of 0.6-1.2 mg/cm can be used, in some embodiments.

Embodiment 48. The pressure sensor of any one of Embodiments 35-47, wherein the yarn is characterized as having a MXene mass loading of from about 10 to about 75 wt %, or from about 15 to about 70 wt %, or from about 20 to about 65 wt %, or from about 25 to about 55 wt %, or from about 30 to about 45 wt %, or even about 40 wt %.

Embodiment 49. The pressure sensor of any one of Embodiments 35-48, wherein the yarn is characterized as having an electical conductivity of from about 30 to about 150 S/cm, or from about 50 to about 120 S/cm, or from 70 to about 110 S/cm, or even from about 90 to about 100 S/cm. The conductivity of the yarns can depend on MXene loading and yarn diameter. As the MXene loading increases and the diameter of the yarn decreases, the overall electrical conductivity of the yarn will be increased. Electrical conductivity in the range of from about 80 to about 100 S/cm is considered especially suitable.

Embodiment 50. The pressure sensor of any one of Embodiments 35-49, wherein the pressure sensor is characterized as having a gauge factor of from about 0.1 to about 10, e.g., from about 0.1 to about 10, from about 1 to about 9, from about 2 to about 8, from about 3 to about 7, from about 4 to about 6, or even about 5.

Embodiment 51. A method, comprising operating a pressure sensor according to any one of Embodiments 35-50.

Embodiment 52. A strain sensor, comprising: a sensor region, the sensor region comprising (a) a substrate fiber, the substrate fiber defining an outer surface coated with a first plurality of MXene particulates, (b) a yarn comprising a plurality of coating fibers, each coating fiber comprising a substrate fiber defining an outer surface coated with a first plurality of MXene particulates, (c) a yarn comprising a plurality of coating fibers, each coating fiber comprising a substrate fiber defining an outer surface coated with a first plurality of MXene particulates and the yarn defining an outer surface coated with a second plurality of MXene particulates; and or (d) a yarn comprising a plurality of fibers, the yarn defining an outer surface coated with a second plurality of MXene particulates, and a charge collector configured to monitor a signal of the sensor region related to a strain experienced by the panel.

Embodiment 53. The strain sensor of Embodiment 52, wherein the sensor region is characterized as being a knitted fabric, a woven fabric, or a nonwoven fabric.

Embodiment 54. A method, comprising operating a strain sensor according to any one of Embodiments 52-53.

### REFERENCES

D. Yu, K. Goh, H. Wang, L. Wei, W. Jiang, Q. Zhang, L. Dai, Y. Chen, Nat. Nanotechnol. 2014, 9, 555.
D. Yu, Q. Qian, L. Wei, W. Jiang, K. Goh, J. Wei, J. Zhang, Y. Chen, Chem. Soc. Rev. 2015, 44, 647.
K. Jost, G. Dion, Y. Gogotsi, J. Mater. Chem. A 2014, 2, 10776.
W. Weng, P. Chen, S. He, X. Sun, H. Peng, Angew. Chem. Int. Ed. 2016, 55, 6140.
Q. Xue, J. Sun, Y. Huang, M. Zhu, Z. Pei, H. Li, Y. Wang, N. Li, H. Zhang, C. Zhi, Small 2017, 13, 1701827.
A. K. Yetisen, H. Qu, A. Manbachi, H. Butt, M. R. Dokmeci, J. P. Hinestroza, M. Skorobogatiy, A. Khademhosseini, S. H. Yun, ACS Nano 2016, 10, 3042.
K. Jost, D. Stenger, C. R. Perez, J. K. McDonough, K. Lian, Y. Gogotsi, G. Dion, Energy Environ. Sci. 2013, 6, 2698.
K. Jost, C. R. Perez, J. K. McDonough, V. Presser, M. Heon, G. Dion, Y. Gogotsi, Energy Environ. Sci. 2011, 4, 5060.
M. Hu, Z. Li, G. Li, T. Hu, C. Zhang, X. Wang, Adv. Mater. Technol. 2017, 2, 1700143.
J. Zhang, S. Seyedin, Z. Gu, W. Yang, X. Wang, J. M. Razal, Nanoscale 2017, 9, 18604.
X. Xiao, T. Li, P. Yang, Y. Gao, H. Jin, W. Ni, W. Zhan, X. Zhang, Y. Cao, J. Zhong, L. Gong, W.-C. Yen, W. Mai, J. Chen, K. Huo, Y.-L. Chueh, Z. L. Wang, J. Zhou, ACS Nano 2012, 6, 9200.
H. Yang, H. Xu, M. Li, L. Zhang, Y. Huang, X. Hu, ACS Appl. Mater. Interfaces 2016, 8, 1774.
V. T. Le, H. Kim, A. Ghosh, J. Kim, J. Chang, Q. A. Vu, D. T. Pham, J.-H. Lee, S.-W. Kim, Y. H. Lee, ACS Nano 2013, 7, 5940.
K. Jost, D. P. Durkin, L. M. Haverhals, E. K. Brown, M. Langenstein, H. C. De Long, P. C. Trulove, Y. Gogotsi, G. Dion, Adv. Energy Mater. 2015, 5, 1401286.
M. Tebyetekerwa, I. Marriam, Z. Xu, S. Yang, H. Zhang, F. Zabihi, R. Jose, S. Peng, M. Zhu, S. Ramakrishna, Energy & Environmental Science 2019.
R. Jalili, J. M. Razal, P. C. Innis, G. G. Wallace, Adv. Funct. Mater. 2011, 21, 3363.
J. Zhang, S. Seyedin, S. Qin, Z. Wang, S. Moradi, F. Yang, P. A. Lynch, W. Yang, J. Liu, X. Wang, J. M. Razal, Small 2019, 15, 1804732.
J. Zhang, S. Seyedin, S. Qin, P. A. Lynch, Z. Wang, W. Yang, X. Wang, Joselito M. Razal, J. Mater. Chem. A 2019, 7, 6401.
N. He, Q. Pan, Y. Liu, W. Gao, ACS Appl. Mater. Interfaces 2017, 9, 24568.
X. Zhao, B. Zheng, T. Huang, C. Gao, Nanoscale 2015, 7, 9399.
T. Xu, X. Ding, Y. Liang, Y. Zhao, N. Chen, L. Qu, Nanoscale 2016, 8, 12113.
V. A. Davis, A. N. G. Parra-Vasquez, M. J. Green, P. K. Rai, N. Behabtu, V. Prieto, R. D. Booker, J. Schmidt, E. Kesselman, W. Zhou, H. Fan, W. W. Adams, R. H. Hauge, J. E. Fischer, Y. Cohen, Y. Talmon, R. E. Smalley, M. Pasquali, Nat. Nanotechnol. 2009, 4, 830.
N. Behabtu, C. C. Young, D. E. Tsentalovich, O. Kleinerman, X. Wang, A. W. K. Ma, E. A. Bengio, R. F. ter Waarbeek, J. J. de Jong, R. E. Hoogerwerf, S. B. Fairchild, J. B. Ferguson, B. Maruyama, J. Kono, Y. Talmon, Y. Cohen, M. J. Otto, M. Pasquali, Science 2013, 339, 182.
Q. Meng, H. Wu, Y. Meng, K. Xie, Z. Wei, Z. Guo, Adv. Mater. 2014, 26, 4100.
M.-Q. Zhao, C. E. Ren, Z. Ling, M. R. Lukatskaya, C. Zhang, K. L. Van Aken, M. W. Barsoum, Y. Gogotsi, Adv. Mater. 2015, 27, 339.
S. Seyedin, E. R. S. Yanza, Joselito M. Razal, J. Mater. Chem. A 2017, 5, 24076.
S. Seyedin, J. M. Razal, P. C. Innis, A. Jeiranikhameneh, S. Beirne, G. G. Wallace, ACS Appl. Mater. Interfaces 2015, 7, 21150.
T. Chen, L. Qiu, Z. Yang, Z. Cai, J. Ren, H. Li, H. Lin, X. Sun, H. Peng, Angew. Chem. Int. Ed. 2012, 51, 11977.
Z. Wang, S. Qin, S. Seyedin, J. Zhang, J. Wang, A. Levitt, N. Li, C. Haines, R. Ovalle-Robles, W. Lei, Y. Gogotsi, R. H. Baughman, J. M. Razal, Small 2018, 14, 1802225.
M. D. Lima, S. Fang, X. Lepró, C. Lewis, R. Ovalle-Robles, J. Carretero-González, E. Castillo-Martínez, M. E. Kozlov, J. Oh, N. Rawat, C. S. Haines, M. H. Haque, V. Aare, S. Stoughton, A. A. Zakhidov, R. H. Baughman, Science 2011, 331, 51.
C. Zhang, B. Anasori, A. Seral-Ascaso, S.-H. Park, N. McEvoy, A. Shmeliov, G. S. Duesberg, J. N. Coleman, Y. Gogotsi, V. Nicolosi, Adv. Mater. 2017, 29, 1702678.
M. R. Lukatskaya, S. Kota, Z. Lin, M.-Q. Zhao, N. Shpigel, M. D. Levi, J. Halim, P.-L. Taberna, M. W. Barsoum, P. Simon, Y. Gogotsi, Nat. Energy 2017, 2, 17105.
M. Alhabeb, K. Maleski, B. Anasori, P. Lelyukh, L. Clark, S. Sin, Y. Gogotsi, Chem. Mater. 2017, 29, 7633.
M. R. Lukatskaya, O. Mashtalir, C. E. Ren, Y. Dall'Agnese, P. Rozier, P. L. Taberna, M. Naguib, P. Simon, M. W. Barsoum, Y. Gogotsi, Science 2013, 341, 1502.
Z. Ling, C. E. Ren, M.-Q. Zhao, J. Yang, J. M. Giammarco, J. Qiu, M. W. Barsoum, Y. Gogotsi, Proc. Natl. Acad. Sci. 2014, 111, 16676.
M. D. Levi, M. R. Lukatskaya, S. Sigalov, M. Beidaghi, N. Shpigel, L. Daikhin, D. Aurbach, M. W. Barsoum, Y. Gogotsi, Adv. Energy Mater. 2015, 5, 1400815.
M. R. Lukatskaya, S.-M. Bak, X. Yu, X.-Q. Yang, M. W. Barsoum, Y. Gogotsi, Adv. Energy Mater. 2015, 5, 1500589.
H. Lin, X. Wang, L. Yu, Y. Chen, J. Shi, Nano Lett. 2017, 17, 384.
F. Meng, M. Seredych, C. Chen, V. Gura, S. Mikhalovsky, S. Sandeman, G. Ingavle, T. Ozulumba, L. Miao, B. Anasori, Y. Gogotsi, ACS Nano 2018, 12, 10518.
K. Maleski, C. E. Ren, M.-Q. Zhao, B. Anasori, Y. Gogotsi, ACS Appl. Mater. Interfaces 2018, 10, 24491-24498.
V. S. Smentkowski, Prog. Surf. Sci. 2000, 64, 1.
T. Habib, X. Zhao, S. A. Shah, Y. Chen, W. Sun, H. An, J. L. Lutkenhaus, M. Radovic, M. J. Green, npj 2D Materials and Applications 2019, 3, 8.
Y. Chae, S. J. Kim, S.-Y. Cho, J. Choi, K. Maleski, B.-J. Lee, H.-T. Jung, Y. Gogotsi, Y. Lee, C. W. Ahn, Nanoscale 2019, 11, 8387-8393.
C. J. Zhang, S. Pinilla, N. McEvoy, C. P. Cullen, B. Anasori, E. Long, S.-H. Park, A. Seral-Ascaso, A. Shmeliov, D. Krishnan, C. Morant, X. Liu, G. S. Duesberg, Y. Gogotsi, V. Nicolosi, Chem. Mater. 2017, 29, 4848-4856.
G.-M. Weng, J. Li, M. Alhabeb, C. Karpovich, H. Wang, J. Lipton, K. Maleski, J. Kong, E. Shaulsky, M. Elimelech, Y. Gogotsi, A. D. Taylor, Adv. Funct. Mater. 2018, 28, 1803360.
D. Xiong, X. Li, Z. Bai, S. Lu, Small 2018, 14, 1703419.
M. Ghidiu, M. R. Lukatskaya, M.-Q. Zhao, Y. Gogotsi, M. W. Barsoum, Nature 2014, 516, 78.
M. Beidaghi, Y. Gogotsi, Energy Environ. Sci. 2014, 7, 867.
M. D. Stoller, R. S. Ruoff, Energy Environ. Sci. 2010, 3, 1294.
A. W. Bayes, J. Text. Inst. Proc. 1957, 48, 255.
L. Liu, Y. Yu, C. Yan, K. Li, Z. Zheng, Nat. Commun. 2015, 6, 7260.
N. Liu, W. Ma, J. Tao, X. Zhang, J. Su, L. Li, C. Yang, Y. Gao, D. Golberg, Y. Bando, Adv. Mater. 2013, 25, 4925.
C. Jin, H.-T. Wang, Y.-N. Liu, X.-H. Kang, P. Liu, J.-N. Zhang, L.-N. Jin, S.-W. Bian, Q. Zhu, Electrochim. Acta 2018, 270, 205.
Y.-Y. Peng, B. Akuzum, N. Kurra, M.-Q. Zhao, M. Alhabeb, B. Anasori, E. C. Kumbur, H. N. Alshareef, M.-D. Ger, Y. Gogotsi, Energy Environ. Sci. 2016, 9, 2847.
N. Kurra, B. Ahmed, Y. Gogotsi, H. N. Alshareef, Adv. Energy Mater. 2016, 6, 1601372.
X. Wang, T. S. Mathis, K. Li, Z. Lin, L. Vlcek, T. Torita, N. C. Osti, C. Hatter, P. Urbankowski, A. Sarycheva, M. Tyagi, E. Mamontov, P. Simon, Y. Gogotsi, Nat. Energy 2019, 4, 241.
J. Lee, H. Kwon, J. Seo, S. Shin, J. H. Koo, C. Pang, S. Son, J. H. Kim, Y. H. Jang, D. E. Kim, T. Lee, Adv. Mater. 2015, 27, 2433-2439.
D. J. Lipomi, M. Vosgueritchian, B. C. K. Tee, S. L. Hellstrom, J. A. Lee, C. H. Fox, Z. Bao, Nat. Nanotechnol. 2011, 6, 788.
Liu, L.; Yu, Y.; Yan, C.; Li, K.; Zheng, Z., Wearable energy-dense and power-dense supercapacitor yarns enabled by scalable graphene-metallic textile composite electrodes. Nature Communications 2015, 6, 7260.
Jost, K.; Durkin, D. P.; Haverhals, L. M.; Brown, E. K.; Langenstein, M.; De Long, H. C.; Trulove, P. C.; Gogotsi, Y.; Dion, G., Natural Fiber Welded Electrode Yarns for Knittable Textile Supercapacitors. Advanced Energy Materials 2015, 5 (4), 1401286.
Wang, Z.; Qin, S.; Seyedin, S.; Zhang, J.; Wang, J.; Levitt, A.; Li, N.; Haines, C.; Ovalle-Robles, R.; Lei, W.; Gogotsi, Y.; Baughman, R. H.; Razal, J. M., High-Performance Biscrolled MXene/Carbon Nanotube Yarn Supercapacitors. Small 2018, 14 (37), 1802225.
Zhang, J.; Seyedin, S.; Gu, Z.; Yang, W.; Wang, X.; Razal, J. M., MXene: a potential candidate for yarn supercapacitors. Nanoscale 2017, 9 (47), 18604-18608.
Hu, M.; Li, Z.; Li, G.; Hu, T.; Zhang, C.; Wang, X., All-Solid-State Flexible Fiber-Based MXene Supercapacitors. Advanced Materials Technologies 2017, 2 (10), 1700143.
Seyedin, S.; Yanza, E. R. S.; Razal, Joselito M., Knittable energy storing fiber with high volumetric performance made from predominantly MXene nanosheets. Journal of Materials Chemistry A 2017, 5 (46), 24076-24082.
S. Park, J. O. Baker, M. E. Himmel, P. A. Parilla, D. K. Johnson, Biotechnol. Biofuels 2010, 3, 10.
M. Ghidiu, M. W. Barsoum, J. Am. Ceram. Soc. 2017, 100, 5395.
J. Halim, K. M. Cook, M. Naguib, P. Eklund, Y. Gogotsi, J. Rosen, M. W. Barsoum, Appl. Surf. Sci. 2016, 362, 406.
I. Persson, L.-Å. Näslund, J. Halim, M. W. Barsoum, V. Darakchieva, J. Palisaitis, J. Rosen, P. O. Å. Persson, 2D Materials 2017, 5, 015002.

What is claimed:

1-34. (canceled)

35. A sensor, comprising:
a first knitted layer comprising a yarn that includes a plurality of constituent fibers,
the yarn comprising a first plurality of MXene particulates,
the first plurality of MXene particulates disposed about at least one of (1) an outer surface of the yarn and (2) a circumference of a constituent fiber of the yarn; and
a monitor in electronic communication with the first knitted layer,
the monitor configured to collect a signal related to a capacitive response of the first knitted layer in response to an applied stress or strain.

36. The sensor of claim 35, further comprising a second knitted layer, the second knitted layer comprising a yarn that includes a plurality of constituent fibers and a coating of MXene particulates disposed about (1) an outer surface of the yarn and (2) a circumference of a constituent fiber of the yarn.

37. The sensor of claim 36, wherein the yarn of the second knitted layer is the yarn of the first knitted layer.

38. The sensor of claim 36, further comprising an dielectric material disposed between the first knitted layer and the second knitted layer.

39. The sensor of claim 38, wherein the dielectric material comprises a rubber.

40. The sensor of claim 35, wherein a constituent fiber comprises a synthetic material.

41. The sensor of claim 35, wherein a constituent fiber comprises a naturally-occurring material.

42. The sensor of claim 35, wherein a constituent fiber comprises any one or more of cotton, bamboo, linen. Modal, regenerated cellulose, nylon, polyester, and viscose.

43. The sensor of claim 42, wherein the naturally-occurring material comprises cotton.

44. The sensor of claim 35, wherein the first plurality of MXene particulates is disposed about a circumference of a constituent fiber of the yarn.

45. The sensor of claim 44, further comprising a second plurality of MXene particulates, and wherein the second plurality of MXene particulates is disposed about an outer surface of the yarn without being disposed about a surface of a constituent fiber of the yarn, the second plurality of MXene particulates having an average cross-sectional dimension larger than a comparable cross-sectional dimension of the first plurality of MXene particulates.

46. The sensor of claim 35, wherein the first plurality of MXene particulates has an average cross-sectional dimension in the range of from about 100 to about 1000 nm.

47. A yarn, comprising:
a plurality of constituent fibers that define a bundle; and
a first plurality of MXene particulates,
the first plurality of MXene particulates disposed about one of (1) an outer surface of the yarn and (2) a circumference of a constituent fiber of the yarn.

48. The yarn of claim 47, wherein the first plurality of MXene particulates is disposed about a circumference of a constituent fiber and wherein a second plurality of MXene particulates is disposed about an outer surface of the bundle, the second plurality of MXene particulates defining an average particle size that is larger than an average particle size of the first plurality of MXene particulates.

49. A sensor, comprising:
a textile that comprises the yarn of claim 47; and
a monitor in electronic communication with the textile,
the monitor configured to collect a signal related to a capacitive response of the textile in response to an applied stress or strain.

50. A capacitor, comprising:
a first portion of a yarn according to claim 47, the first portion further comprising an electrolyte; and
a second portion of a yarn according to claim 47, the second portion further comprising an electrolyte.

51. The capacitor of claim 50, wherein the first portion and second portion are arranged parallel to one another.

52. A textile, comprising:
a plurality of fibers,
each fiber comprising a coating that includes a first plurality of MXene particulates, and
the plurality of fibers defining a yarn that defines an outer surface, the outer surface of the yarn having thereon a coating that comprises a second plurality of MXene particulates,
the first plurality of MXene particulates having a smaller average particle size than the second plurality of MXene particulates.

53. The textile of claim 52, wherein the plurality of first MXene particulates has an average cross-sectional dimension less than a corresponding average cross-sectional dimension of the plurality of second MXene particulates.

54. The textile of claim 52, wherein the fibers are naturally-derived.
